(19) United States
(12) Patent Application Publication
(10) Pub. No.: US 2025/0234317 A1
(43) Pub. Date: Jul. 17, 2025

(54) APPARATUS AND METHOD FOR MANAGING SUBSCRIPTION DATA FOR MULTI-ACCESS MOBILITY IN WIRELESS COMMUNICATION SYSTEM

(71) Applicant: ELECTRONICS AND TELECOMMUNICATIONS RESEARCH INSTITUTE, Daejeon (KR)

(72) Inventors: Jeoung Lak HA, Daejeon (KR); Changki KIM, Daejeon (KR)

(73) Assignee: ELECTRONICS AND TELECOMMUNICATIONS RESEARCH INSTITUTE, Daejeon (KR)

(21) Appl. No.: 19/016,960

(22) Filed: Jan. 10, 2025

(30) Foreign Application Priority Data
Jan. 11, 2024 (KR) 10-2024-0004678
Feb. 8, 2024 (KR) 10-2024-0019672
Feb. 8, 2024 (KR) 10-2024-0019673
Apr. 1, 2024 (KR) 10-2024-0044349
Apr. 2, 2024 (KR) 10-2024-0044716
Apr. 3, 2024 (KR) 10-2024-0045251
Apr. 5, 2024 (KR) 10-2024-0046907
Jul. 12, 2024 (KR) 10-2024-0092515
Aug. 7, 2024 (KR) 10-2024-0105376
Aug. 8, 2024 (KR) 10-2024-0105817
Dec. 12, 2024 (KR) 10-2024-0184792

(51) Int. Cl. H04W 60/00; H04W 48/18

(52) U.S. Cl. CPC H04W 60/00; H04W 48/18

(57) ABSTRACT

The present disclosure relates generally to wireless communication systems, and more specifically to devices and methods for managing subscription information for multi-access mobility in a wireless communication system. A method for operating a registration for a network function repository function (NRF) by a network function element supporting multi-access of a wireless communication system includes requesting, by the network function element, the registration with the NRF, in which the requesting of the registration includes whether to support multi-access, and whether to support multi-access is included in at least one of NFProfile, AMFProfile, SMFProfile, UPFProfile or PCFProfile.

### CROSS REFERENCE TO RELATED APPLICATION

The present application claims priority to Korean Patent Application No. 10-2024-0184792, filed Dec. 12, 2024, Korean Patent Application No. 10-2024-0004678, filed Jan. 11, 2024, Korean Patent Application No. 10-2024-0019672, filed Feb. 8, 2024, Korean Patent Application No. 10-2024-0019673, filed Feb. 8, 2024, Korean Patent Application No. 10-2024-0044349, filed Apr. 1, 2024, Korean Patent Application No. 10-2024-0044716, filed Apr. 2, 2024, Korean Patent Application No. 10-2024-0045251, filed Apr. 3, 2024, Korean Patent Application No. 10-2024-0046907, filed Apr. 5, 2024, Korean Patent Application No. 10-2024-0092515, filed Jul. 12, 2024, Korean Patent Application No. 10-2024-0105376, filed Aug. 7, 2024, and Korean Patent Application No. 10-2024-0105817, filed Aug. 8, 2024, the entire contents of which is incorporated herein for all purposes by this reference.

### BACKGROUND OF THE INVENTION

### Field of the Invention

The present disclosure relates generally to a wireless communication system and, more specifically, to an apparatus and a method for managing subscription information for multi-access mobility in a wireless communication system.

### Description of the Related Art

Access traffic steering, switching, and splitting (ATSSS) in the related art supports services for one user ID by steering, switching, and splitting of traffic for connections via 3GPP and connections via Non-3GPP. Steering refers to selecting one of two or more access networks to perform new traffic transmission, and switching refers to moving traffic transmission from an access network to a new access network. In addition, splitting refers to distributing traffic among two or more access networks.

Multi-access steering, switching, and splitting (MASSS) supports steering, switching, and splitting among two or more access networks within a communication network or among access networks belonging to different communication networks, with two or more user IDs.

In order to support two or more connections in one or more 3GPP communication networks, two or more user IDs or terminal IDs corresponding to them are required.

Steering refers to selecting an access when starting a new service data, switching refers to changing the service data path to another access while using the service data, and splitting refers to distributing the service data into two or more different accesses to use them. Herein, the access refers to an access network including a public land mobile network and or radio access technology (PLMN/RAT).

When there are two access networks in the MASSS, it is referred to as DualSteer. Although this disclosure is based on DualSteer, it may be expanded to three or more multiple connections using three or more user IDs or user terminal IDs.

### SUMMARY OF THE INVENTION

Based on the discussion described above, an objective of the present invention is to provide an apparatus and method for linking and managing subscription information for two or more user IDs for a multi-access environment in a wireless communication system.

In addition, the present disclosure provides an apparatus and method for performing subscriber authentication, service usage authorization verification, and registration identifier management in a registration procedure for multi-access services in a wireless communication system.

In addition, the present disclosure provides an apparatus and method for performing generation, transmission, and management of DualSteer policy for supporting multi-access services in a wireless communication system.

In addition, the present disclosure provides an apparatus and method for performing registration and search of network functions for supporting multi-access services in a wireless communication system.

According to various embodiments of the present disclosure, the present disclosure relates generally to a wireless communication system, and more specifically to an apparatus and a method for managing subscription information for multi-access mobility in a wireless communication system. A method for operating a registration for a network function repository function (NRF) by a network function element supporting multi-access of a wireless communication system includes requesting, by the network function element, the registration with the NRF, in which the requesting of the registration includes whether to support multi-access, and whether to support multi-access is included in at least one of NFProfile, AMFProfile, SMFProfile, UPFProfile or PCFProfile.

According to various embodiments of the present disclosure, a method for providing DualSteer policy in a wireless communication system includes identifying traffic characteristics of an individual subscription permanent identifier (SUPI); determining radio access technology (RAT) selection information based on the identified traffic characteristics; and generating the DualSteer policy including the RAT selection information.

According to various embodiments of the present disclosure, an apparatus for providing DualSteer policy in a wireless communication system includes a transceiver; and a control unit operably connected to the transceiver, in which the control unit identifies traffic characteristics of an individual subscription permanent identifier (SUPI), determines radio access technology (RAT) selection information based on the identified traffic characteristics, and generates the DualSteer policy including the RAT selection information.

The apparatus and method according to various embodiments of the present disclosure allows for efficient management of two or more user IDs in one terminal, thereby stably providing multi-access services.

The apparatus and method according to various embodiments of the present disclosure allows for efficient management of duplicate subscription information, thereby reducing waste of resources.

The apparatus and methods according to various embodiments of the present disclosure can increase data reliability by easily maintaining consistency between subscription information, thereby enabling real-time service provision by immediately reflecting related information when updating subscription information.

The apparatus and method according to various embodiments of the present disclosure may enhance security by systematically performing user authentication and authorization verification.

The apparatus and method according to various embodiments of the present disclosure may increase the utilization of network resources by efficiently managing sessions through registration identifiers, and may improve user experience by managing service priorities through distinction of primary or secondary subscription permanent identifier (SUPI).

The apparatus and method according to various embodiments of the present disclosure may maximize the service quality by selecting an optimal network according to the traffic characteristics.

The apparatus and method according to various embodiments of the present disclosure may increase the network adaptability by dynamically applying the policy according to the network situation, and may provide service flexibility by flexibly combining the user-defined policy and the operator policy.

The apparatus and method according to various embodiments of the present disclosure may allow for optimization of network resources by selecting an efficient network function considering whether to support the DualSteer service, and ensure continuity of service by searching an appropriate network function when interconnecting public land mobile networks (PLMNs).

It should be understood that the effects obtainable from the present disclosure are not limited to the effects mentioned above, and other effects not mentioned will be clearly understood by those skilled in the art to which the present disclosure belongs from the description below.

### BRIEF DESCRIPTION OF THE DRAWINGS

FIG. 1 illustrates an identifier (ID) of a public land mobile network (PLMN), according to an embodiment of the present disclosure.

FIG. 2 illustrates an international mobile subscriber identity (IMSI), according to an embodiment of the present disclosure.

FIG. 3 illustrates a subscription concealed identifier (SUCI) that encrypts a SUPI, according to an embodiment of the present disclosure.

FIG. 4 illustrates a globally unique temporary identifier (GUTI) that is allocated after a user or terminal with SUPI connects to the network, according to an embodiment of the present disclosure.

FIG. 5 illustrates a structure of a 5G wireless communication network, according to an embodiment of the present disclosure.

FIG. 6 illustrates a detailed diagram of a wireless communication network, according to an embodiment of the present disclosure.

FIG. 7 illustrates an example of use of a portion of subscription information data, according to an embodiment of the present disclosure.

FIG. 8 illustrates an example of RAN coverage, according to an embodiment of the present disclosure.

FIG. 9 illustrates a multi-access device, according to an embodiment of the present disclosure.

FIG. 10 illustrates a basic structural type of a DualSteer device, according to an embodiment of the present disclosure.

FIG. 11 illustrates a DualSteer device convergence function (DCF) implementation structure of a DualSteer device, according to an embodiment of the present disclosure.

FIG. 12 illustrates a first example of multi-access, according to an embodiment of the present disclosure.

FIG. 13 illustrates a second example of multi-access, according to an embodiment of the present disclosure.

FIG. 14 illustrates a third example of multi-access, according to an embodiment of the present disclosure.

FIG. 15 illustrates a fourth example of multi-access, according to an embodiment of the present disclosure.

FIG. 16 illustrates an example of subscription information management for multi-access in one communication network.

FIG. 17 illustrates an example of subscription information management for multi-access in two communication networks, according to an embodiment of the present disclosure.

FIG. 18 illustrates an example of dual-steer related items of subscription information, according to an embodiment of the present disclosure.

FIG. 19 illustrates an example of service traffic information, according to an embodiment of the present disclosure.

FIG. 20 illustrates an example of subscription information, according to an embodiment of the present disclosure.

FIG. 21 illustrates another example of subscription information, according to an embodiment of the present disclosure.

FIG. 22 illustrates an example of AM subscription data of subscription information, according to an embodiment of the present disclosure.

FIG. 23 illustrates an example of policy subscription data of subscription information, according to an embodiment of the present disclosure.

FIG. 24 illustrates an example of PLMN/RAT combination information and priority, according to an embodiment of the present disclosure.

FIG. 25 illustrates a first example of DualSteer policy, according to an embodiment of the present disclosure.

FIG. 26 illustrates a second example of DualSteer policy, according to an embodiment of the present disclosure.

FIG. 27 illustrates a third example of DualSteer policy, according to an embodiment of the present disclosure.

FIG. 28 illustrates a fourth example of DualSteer policy, according to an embodiment of the present disclosure.

FIG. 29 illustrates an example of information display for location of FIG. 28, according to an embodiment of the present disclosure.

FIG. 30 illustrates the existing UE registration procedure, according to various embodiments of the present disclosure.

FIG. 31 illustrates the existing UE registration procedure, according to various embodiments of the present disclosure.

FIG. 32 illustrates the existing UE configuration update procedure, according to various embodiments of the present disclosure.

FIG. 33 illustrates the existing UE configuration update procedure, according to an embodiment of the present disclosure.

FIG. 34 illustrates an example of registering two SUPIs of a DualSteer device to different RANs, respectively, according to an embodiment of the present disclosure.

FIG. 35 illustrates an example of a procedure for registration and policy provision to UE, according to an embodiment of the present disclosure.

FIG. 36 illustrates another example of a procedure for registration and policy provision to UE, according to an embodiment of the present disclosure.

FIG. 37 illustrates a procedure for deregistration of UE, according to an embodiment of the present disclosure.

FIG. 38 illustrates a procedure for deregistration initiated in a network, according to an embodiment of the present disclosure.

FIG. 39 illustrates an example of registering a functional element in a network, according to an embodiment of the present disclosure.

FIG. 40 illustrates an example of searching a functional element in a network, according to an embodiment of the present disclosure.

FIG. 41 illustrates a search for a PLMN-to-PLMN functional element, according to an embodiment of the present disclosure.

FIG. 42 illustrates a configuration diagram of a terminal in a wireless communication system, according to various embodiments of the present disclosure.

FIG. 43 illustrates a configuration of a network entity in a wireless communication system, according to various embodiments of the present disclosure.

### DETAILED DESCRIPTION OF THE INVENTION

The terms used herein are used only to describe specific embodiments and may not be intended to limit the scope of other embodiments. A singular expression may include plural expressions unless the context clearly indicates otherwise. Terms used herein, including technical or scientific terms, may have the same meaning as commonly understood by a person of ordinary skill in the art described in this disclosure. Terms defined in general dictionaries among the terms used herein may be interpreted as having the same or similar meaning as the meaning they have in the context of the relevant technology, and shall not be interpreted in an ideal or excessively formal meaning unless explicitly defined in this disclosure. In some cases, even if a term is defined in this disclosure, it cannot be interpreted to exclude embodiments of this disclosure.

The various embodiments of the present disclosure described below are described by way of example using a hardware-based approach. However, since the various embodiments of the present disclosure include techniques using both hardware and software, the various embodiments of the present disclosure do not exclude a software-based approach.

In addition, in the detailed description and claims of the present disclosure, “at least one of A, B, and C” may mean “only A”, “only B”, “only C”, or “any combination of A, B, and C”. In addition, “at least one of A, B, or C” or “at least one of A, B, and/or C” may mean “at least one of A, B, and C”.

This disclosure relates to an apparatus and method for efficiently managing subscription information for a multi-access environment in a wireless communication system and stably supporting services through registration procedures and policy provision. Specifically, the present disclosure describes a technology for performing subscription information linkage, policy provision, network function management, and traffic control for a multi-access service including DualSteer in a wireless communication system.

Terms referring to signals, terms referring to channels, terms referring to control information, terms referring to network entities, terms referring to components of apparatus, etc., which are used in the following, are used for convenience of explanation. Therefore, the present disclosure is not limited to the terms described below, and other terms having equivalent technical meanings may be used.

In addition, although the present disclosure describes various embodiments using terms used in some communication standards (e.g., 3rd Generation Partnership Project (3GPP)), these are only examples for the purpose of explanation. The various embodiments of the present disclosure may be easily modified and applied in other communication systems.

Access traffic steering, switching, and splitting (ATSSS) in the related art supports services for one user ID by steering, switching, and splitting of traffic for connections via 3GPP and connections via Non-3GPP. Steering refers to selecting one of two or more access networks to perform new traffic transmission, and switching refers to moving traffic transmission from an access network to a new access network. In addition, splitting refers to distributing traffic among two or more access networks.

Multi-access steering, switching, and splitting (MASSS) supports steering, switching, and splitting among two or more access networks within the same communication network or among access networks belonging to different communication networks, with two or more user IDs.

In order to make two or more connections in one or more 3GPP communication networks, two or more user IDs or terminal IDs are required.

Steering refers to selecting an access when starting a new service data, switching refers to changing the service data to another access while using the service data, and splitting refers to dividing the service data into two or more different accesses to use them. Herein, access refers to an access network as well as public land mobile network/radio access technology (PLMN/RAT).

When there are two access networks in the MASSS, it is referred to as DualSteer. Although this disclosure is based on DualSteer, it may be expanded to three or more connections.

Since the MASSS of this disclosure supports two or more user IDs, unlike the ATSSS in the related art, this requires linking subscription information for two or more user IDs. In addition, the subscription information of the subscriber for the MASSS is required to authenticate the subscriber during the registration process and verify the authority to use the service, and also required to provide a policy for the service use.

The present disclosure relates to a method for providing subscription information management and registration, and policies for providing mobility for connections through two or more access networks (radio access networks, RANs) within a single communication network (public land mobile network, PLMN) or connections through access networks belonging to different communication networks.

Mobility for connections through different access networks includes to the policy for which RAN a terminal will select and register, which is capable of registering or sessioning with two or more subscription permanent identifiers (SUPIs) in two or more RANs belonging to one PLMN or two or more RANs belonging to different PLMNs.

### [PLMN ID]

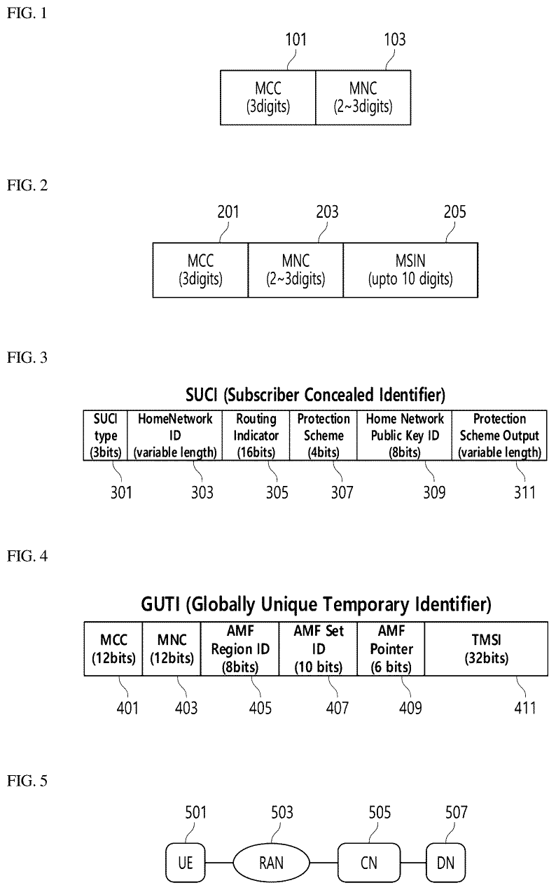

FIG. 1 illustrates an identifier (ID) of a public land mobile network (PLMN), according to an embodiment of the present disclosure.

Referring to FIG. 1, the ID of the PLMN may consist of a mobile country code (MCC) and a mobile network code (MNC). The MCC 101 consists of 3 digits and is assigned to each country by ITU-T. For example, Korea uses MCC 101 of 450 and 467, and the United States uses MCC 101 of 310, 311, 312, etc., multiple MCCs may be assigned to one country.

The MNC 103 consists of 2˜3 digits and may be assigned to mobile operators by the telecommunications regulatory authority of each country. The same mobile operator may have multiple MNCs 103.

The PLMN ID may be used for various purposes such as network identification, routing, charging, and security. The network identification may be used to distinguish a subscriber's home public land mobile network (HPLMN) and a visited public land mobile network (VPLMN), route traffic and signaling messages during international roaming, identify roaming users, and settle accounts between networks. In addition, the security may be strengthened through network authentication and fraud prevention.

In particular, the DualSteer service of the present disclosure allows the target network to be designated in the network identification and steering policy when connecting multiple PLMNs or to be used as an identifier when connecting between multiple networks. The PLMN ID may have an important meaning as an identification system that serves as the basis for identifying and selecting multiple networks for the DualSteer service in the present disclosure.

### [IMSI]

FIG. 2 illustrates an international mobile subscriber identity (IMSI), according to an embodiment of the present disclosure.

Referring to FIG. 2, the IMSI consists of up to 15 digits and may include a mobile country code (MCC) 201, a mobile network code (MNC) 203, and a mobile subscription identification number (MSIN) 205.

The MCC 201 consists of three digits and is a code assigned to each country by ITU-T, and may play a role in identifying the country in the same way as described in FIG. 1.

The MNC 203 consists of 2˜3 digits, and may be used for the same purpose as in FIG. 1, as a code that distinguishes mobile communication service providers within a country.

The MSIN 205 consists of up to 10 digits, and may be configured with a unique identification number that mobile communication service providers assign to distinguish subscribers and be assigned sequentially or according to a specific system within the communication company.

The IMSI is mainly used for the following purposes:

(1) Subscriber Identification: performs subscriber authentication and profile inquiry when connecting the network, and is used in the charging and billing process.

(2) DualSteer Service Utilization: enables multiple access identification through multiple IMSIs, provides the basis for linkedSUPI information, and is used as the basis for distinguishing between two SUPIs or primary and secondary SUPIs used in DualSteer.

(3) Security: IMSI is not transmitted in plaintext for security, but is transmitted in the form of an encrypted subscription concealed identifier (SUCI) or replaced with a globally unique temporary identifier (GUTI).

(4) Roaming: used to identify the home network and the subscriber when roaming abroad, and to link charging information.

In this disclosure, the IMSI plays a key role in understanding the basic structure of managing and linking multiple subscriber identifiers for DualSteer service.

The subscription permanent identifier (SUPI) is expressed using the IMSI or a network access identifier (NAI), in which the NAI may be expressed according to each network characteristic and may often have a form similar to an email address. For example, the NAI may appear in a format such as user@domain.com and may be utilized to uniquely identify a user in inter-network communication. This structure is designed to efficiently perform user authentication and network identification.

### [SUCI]

FIG. 3 illustrates a subscription concealed identifier (SUCI) that encrypts a SUPI, according to an embodiment of the present disclosure.

Referring to FIG. 3, the SUCI is designed to protect the privacy of the SUPI. The SUCI may include a SUCI type 301, a home network ID 303, a routing indicator 305, a protection scheme ID 307, a home network public key ID 309, and a protection scheme output 311.

The SUCI type 301 has a size of 3 bits and may play a role in distinguishing whether the SUPI is IMSI or NAI. The home network ID 303 consists of a MCC and a MNC and may identify the subscriber's home network. The home network ID 303 may have a variable length size.

The routing indicator 305 may include additional information used for network internal routing optimization. The routing indicator 305 may have a size of 15 bits.

The fields related to the encryption method include the protection scheme ID 307 and the home network public key ID 309. The protection scheme ID 307 indicates the used encryption method such as elliptic curve integrated encryption scheme (ECIES), and the home network public key ID may identify a version of the public key used for encryption.

The protection scheme ID 307 may have a size of 4 bits, and the home network public key ID 309 may have a size of 8 bits.

Th protection scheme output 311 contains actual encrypted MSIN data, which may be an encrypted value of a MSIN part of the SUPI.

The SUCI has several important features. First, it protects privacy so that the SUPI is not exposed in the wireless section, which results in preventing subscriber tracking and IMSI catching attacks. Second, it transmits the identifier safely through asymmetric encryption, and it may only be used in the network authentication process since the SUCI may only be decrypted in the home network. Finally, in the DualSteer service, the SUCI may safely manage multiple SUPIs, guarantee privacy even in a multi-access environment, and provide high security when connecting to different access networks.

In conclusion, the SUCI may be a key technology that enhances the security of SUPI and allow for stable authentication and privacy protection in wireless communication environments. This disclosure proposes a stable and secure identifier management method in multi-access scenarios such as DualSteer service through such structure and role of the SUCI.

### [GUTI]

FIG. 4 illustrates a globally unique temporary identifier (GUTI) that is allocated after a user or terminal with SUPI accesses the network, according to an embodiment of the present disclosure.

Referring to FIG. 4, the GUTI is designed as a temporary identifier of a terminal to enhance privacy protection and security of subscribers.

The GUTI may include the following main fields.

The GUTI may include a MCC 401 and a MNC 403, and may identify the network to which the terminal is connected using MCC 401 and MNC 403. The MCC 401 is a code that distinguishes a country, and the MNC 403 is a code that distinguishes a mobile communication service provider, which may enable the GUTI to be valid in a specific network. The MCC 401 and the MNC 403 may each have a size of 12 bits.

An AMF region ID 405 has a size of 8-bit and may identify a geographical or logical division of a network.

An AMF set ID 407 may be a 10-bit identifier for identifying an AMF group within the same region.

An AMF pointer 409 may be a value of 6-bit, which is used to designate a specific AMF instance.

A temporary mobile subscriber identity (TMSI) 411 is a 32-bit temporary identification number, which may be assigned to a terminal by the AMF and periodically renewed.

The GUTI has the following main features and uses:

First, the GUTI is a temporary identifier that is valid only for a certain period of time and is periodically updated with a new value, which results in preventing direct exposure of the SUPI.

Second, the GUTI is utilized to track and page the location of a terminal, including AMF area information, and may enable efficient mobility management.

Third, the GUTI may strengthen security by protecting subscriber privacy, minimizing exposure of the SUPI, and preventing tracking attacks.

In particular, the DualSteer service allows the GUTI to be individually allocated for multiple connections and temporary identifier to be managed independently for each connection, which results in providing safe identification system in the multi-access environment and improving security for various connections.

In conclusion, the GUTI acts as a temporary identifier of a terminal instead of the SUPI, supports mobility and security of the terminal, and enables stable service provision in a multi-access environment. Although the SUPI is described herein, SUCI/GUTI/GPSI or MSIN/NAI/TMSI may be used depending on the embodiment.

### [5G Mobile Communication Network Structure]

FIG. 5 illustrates a structure of a 5G wireless communication network, according to an embodiment of the present disclosure. Specifically, FIG. 5 shows a basic structure of a 5G mobile communications network, which is configured with four main components that interact with each other to provide various services and functions.

Referring to FIG. 5, user equipment (UE) 501 may include, as a terminal device used by a user, a smartphone, tablet, IoT device, etc. The DualSteer service is operated as a terminal that supports multiple connections to allow a user to provide a function of connecting to various networks simultaneously. It may include a wireless access technology that may connect to one or more various access networks.

A radio access network (RAN) 503 is a wireless section that connects the UE and a core network, and may be configured with a base station and related equipment. The RAN may support various forms such as next generation Node B (gNB) based on 5G New Radio, evolved Node B (eNB) for interconnection with previous generations, and satellite RAN to allow for flexible network access.

The core network (CN) 505 may perform, as a 5G core network, important roles such as mobility management, session management, authentication and security, subscriber data management, and policy control. This may ensure efficient operation and stability of the network.

A data network (DN) 507 is an external data network that includes the Internet, corporate networks, application servers, etc., and may provide various services to end users.

The DualSteer service plays an important role in this network structure.

First, the DualSteer service supports multiple RAN connections, which allows for simultaneous connections through different RANs, selection and switching between RANs (steering and switching), and traffic distribution (splitting).

Second, the DualSteer service may distribute the load through efficient network operation, ensure service continuity, and optimize Quality of Service (QOS).

Third, the DualSteer service may provide improved service quality by supporting various access scenarios and selecting the optimal path according to the situation.

In conclusion, FIG. 5 describes the 5G network environment where the DualSteer service is implemented, and shows the basic structure that enables flexible and efficient connection and data processing in complex networks.

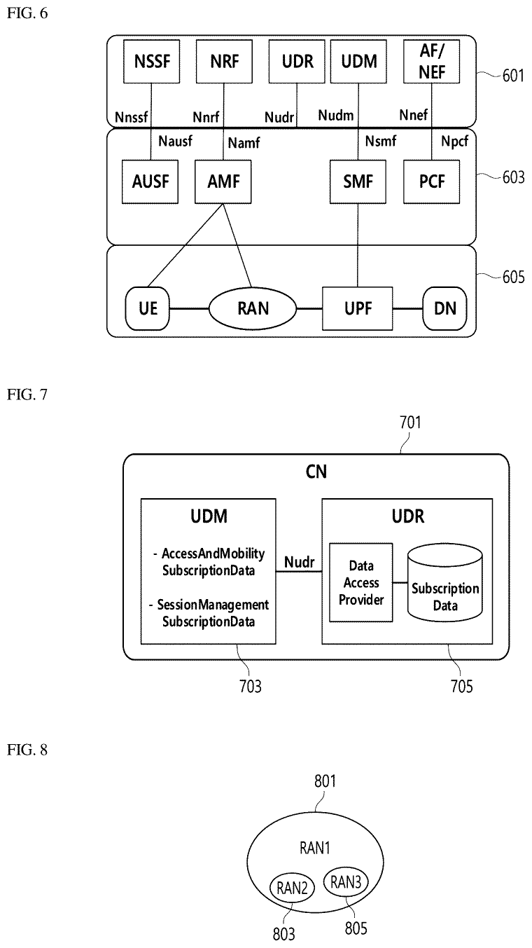

FIG. 6 illustrates a detailed diagram of a wireless communication network, according to an embodiment of the present disclosure.

Specifically, FIG. 6 details main functional elements of the 5G core network and connections between them, in which operation of the network may be largely divided into three layers: a data storage or management layer 601, a control layer 603, and a user plane 605.

Referring to FIG. 6, the data storage or management layer 601 may be responsible for a function of managing and storing core data of the network. It may include a network slice selection function (NSSF) that selects a network slice, a network repository function (NRF) that supports network function registration and search, a unified data repository (UDR) that stores subscriber data, a unified data management (UDM) that performs subscriber data management and authentication, and a network exposure function (NEF) that provides connectivity with an external network.

The control layer 603 may perform major control functions, as the center of network operation. An access and mobility management function (AMF) may be in charge of NAS message processing, terminal mobility management, and location registration management. A session management function (SMF) performs PDU session management, interaction with the UPF, and session context management, and a policy control function (PCF) may perform roles such as network policy creation and distribution, DualSteer policy management, etc.

The user plane 605 is responsible for a data path, which connects from the UE to RAN, UPF, and then DN. The user plane function (UPF) is in charge of traffic processing and may optimize the efficiency of data transmission.

The main roles of the 5G core network in DualSteer service are as follows: The UDM/UDR manages DualSteer subscription information and linkedSUPI, and provides subscriber authentication data. The AMF may perform DualSteer registration processing and DualSteer connection management, and manages DSregId. The SMF may manage DualSteer sessions, controls traffic steering and switching, and may coordinate UPF selection. The PCF may generate DualSteer policies, deliver them to the network, and manage the priority of connections to be applied to traffic.

In a wireless communication network, the DualSteer service may transfer control signaling and data between network functions through various interfaces, and support the implementation and management of services. These interfaces may be largely divided into service-based interface, control layer interface, and user plane interface.

The service-based interface operates at the upper layer and may support the service provision of each network function. Nnssf may provide network slice selection function provided by the NSSF, Nnrf may provide network function search and registration of NRF, Nudr may provide data storage and inquiry function of the UDR, Nudm may provide subscriber data management of the UDM, and Nnef may provide external network linkage function of the NEF.

The control layer interface may perform a role of transmitting control messages of the network. Namf may support the mobility management and location registration management services provided by the AMF, Nsmf may perform the session management function provided by the SMF, and Npcf may perform the network policy management function provided by the PCF.

The DualSteer service allow each interface to perform the following roles. Nudm may query and update DualSteer-related subscription information and manage linkedSUPI information. N1/N2 may handle DualSteer registration signaling, policy delivery, and DSregId delivery. Npcf may be responsible for creating DualSteer policy and access control policy and updating the policies. Nsmf may manage DualSteer sessions and manage steering/switching control and session status.

These interfaces efficiently may transmit control signaling and data for the DualSteer service, and provide stable and flexible services through cooperation between each network function.

### [Subscription Information Data]

FIG. 7 illustrates an example of use of a portion of subscription information data, according to an embodiment of the present disclosure.

Referring to FIG. 7, FIG. 7 illustrates an interrelationship between a unified data management (UDM) 703 and a unified data repository (UDR) 705 included in CN 701 and an Nudr service interface to show a subscription information management structure.

The subscription information may include AccessAndMobilitySubscriptionData (access and mobility management information) and SessionManagementSubscriptionData (session management information), and also include subscription information data related to other various services.

The subscription information management method may be divided into three types.

First, a UDM direct management method may provide an independent data management structure in which the UDM directly stores and manages subscription information.

Second, a UDR linkage management method is a centralized data management method, where the subscription information data is stored in the UDR and the UDM may manage it through the Nudr service.

Third, a network function internal management method may provide a distributed data management structure that internally manages data in AMF, SMF, and policy control function (PCF) without using UDM/UDR.

In particular, the DualSteer service may utilize this subscription information management structure to link and manage multiple SUPIs, store and process linkedSUPI information, and manage DualSteer-related policies and settings. In addition, it may process data required for subscriber authentication and authorization verification to enhance the stability and security of the service.

That is, FIG. 7 shows the flexibility of the management and storage method of subscription information data in the 5G core network, and may effectively explain the data management structure for supporting advanced multi-access services such as DualSteer.

### [Types of RAN]

Table 1 shows types of RAN according to an embodiment of the present disclosure. Specifically, it shows how to classify types of RAN according to various criteria and how to make selection and utilization according to characteristics of RAN and needs of users.

TABLE 1

| Classification criteria | Type of RAN | Note |
|---|---|---|
| Frequency-specific | Low band (<1 GHz), | The frequency criteria |
| | Mid band (<3 GHz), | for dividing each band may be |
| | High band (<6 GHz), | different, and more |
| | Very High band (>6 GHz) | specifically, be expressed |
| | | using values representing |
| | | frequency ranges or values |
| | | representing frequency bands. |
| Altitude-specific | Terrestrial | Satellites may be |
| Earth | | |
| Orbi | | |
| | Low Earth Orbi | |
| | (LEO) | Non-terrestrial. |
| | Medium Earth Orbit | |
| | (MEO) | |
| | Geosynchronous | |
| | Orbit (GEO) | |
| Wireless Access | E-UTRAN | GRAN (GSM RAN): |
| Technology (RAT) | NG-RAN | 2nd generation |
| | Satellite NG-RAN | UTRAN (UMTS |
| | Satellite E-UTRAN | RAN): 3rd generation |
| | | E-UTRAN (Evolved |
| | | UTRAN): 4th generation |
| | | NG-RAN (Next |
| | | Generation RAN): 5th |
| | | generation |
| Operation-specific | PLMN | (Public Non-Public |
| | network) | Networks (NPN) is a private |
| | PNI-NPN (Public | network |
| | Network Integrated NPN) | |
| | Private network provided on | |
| | public network | |
| | S-NPN (Standalone | |
| | NPN) Independently installed | |
| | private network | |

The RAN may be first classified by frequency. The RAN may be classified into low band (<1 GHz), mid band (<3 GHz), high band (<6 GHz), very high band (>6 GHz), in which frequency range or band value may be further divided as needed.

In altitude-specific classification, the RAN may be classified based on the physical location of the network. This is divided into terrestrial-based network and non-terrestrial satellite communications network, in which the satellite communications may be classified by orbit into low earth orbit (Leo), medium earth orbit (Meo), and geosynchronous orbit (GEO).

A radio access technology (RAT) is classified based on technology generation and standards. It may include GSM RAN (GRAN), UMTS RAN (UTRAN), evolved UTRAN (E-UTRAN), and next generation RAN (NG-RAN), and also include satellite-based satellite NG-RAN and satellite E-UTRAN.

Operation-specific classification is based on the network operation method. A PLMN may refer to a public network provided to the public, and a non-public network (NPN) may refer to a private network operated in a limited manner for specific users or organizations. The NPN may be further divided into a public network-based private network (PNI-NPN) and an independently installed private network (S-NPN).

The RAN may have differences in coverage, data speed, and rates depending on each technical characteristics. A user may select an appropriate RAN considering their mobility characteristics, required data speed, and cost. In addition, when the RAN or RAN service provided differs depending on the communication network, the user may select the communication network that provides the RAN. In addition, the RAN may be further subdivided based on characteristics such as cell structure, frequency band, etc. The selection of RAT described below may broadly include not only the selection of radio access technology in Table 1, but also the selection of the type of RAN in Table 1.

Such RAN classification characteristics may be utilized as important criteria for selecting and switching the optimal access network in the DualSteer service, which results in satisfying user needs and network performance in various network environments.

### [RAN Coverage]

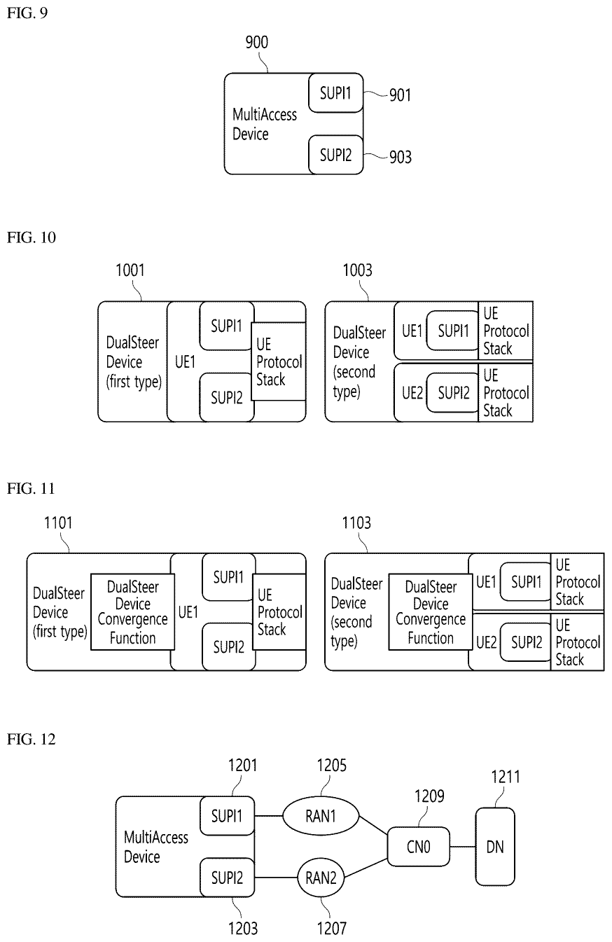

FIG. 8 illustrates an example of RAN coverage, according to an embodiment of the present disclosure. Specifically, FIG. 8 illustrates coverage of a radio access network (RAN), which may explain mobility and service continuity in a multi-RAN environment. The RANs in FIG. 9 may be various RANs having frequency-specific, altitude-specific, RAT-specific, and operation-specific characteristics as described in Table 1.

Referring to FIG. 8, in the coverage structure, a RAN1 701 may provide the widest coverage, and a RAN2 703 and a RAN3 705 may form smaller areas within the RAN1. For example, when a user uses a service in the area of the RAN2 703 and then moves to the area of the RAN3 705, the user may need to receive the service through the RAN1 701 to ensure service continuity.

These RANs may be multiple RANs belonging to one communication network, or may be RANs belonging to different communication networks. In the case of belonging to the same communication network, the service continuity may be ensured with a multi-RAN structure managed by a single operator. On the other hand, in the case of RANs belonging to different communication networks, the service switching must be achieved through linkage between multiple operators.

In conclusion, FIG. 8 describes the coverage overlap and switching process in a multi-RAN environment, and illustrates important concepts for selecting the optimal access network and maintaining the service continuity in the DualSteer service.

### [Multi-Access Device]

FIG. 9 illustrates a multi-access device, according to an embodiment of the present disclosure. Specifically, FIG. 9 illustrates a basic structure of the multi-access device, and illustrates key terminal configurations for implementing a multi-access service such as the DualSteer service of the present disclosure.

Referring to FIG. 9, a multi-access device 900 is a device that is capable of connecting to one or more radio access networks (RANs) or one or more communication networks, which may include a plurality of subscription permanent identifiers (SUPIs) 901, 903. The SUPI may be understood as a user ID or a used terminal ID, which may serve as a unique identifier for each access network.

In particular, when the multi-access device 900 can access two access networks, it is called a DualSteer device (DSD). The DSD is a form of multi-access, and the DualSteer are used interchangeably with multi-access herein. Two access networks will be described herein for convenience.

The multi-access device has the following utilization scenarios. First, it may connect to multiple RANs to allow for switching between networks and traffic distribution. Second, it may connect to multiple communication networks to provide mutually complementary services. Third, it may independently manage each network connection through multiple SUPIs and support flexible connections between users and networks.

In conclusion, FIG. 9 illustrates the basic device configuration of the multi-access device 900 and DualSteer service implementation, and may provide core concepts for access management and service continuity in a multi-network environment.

FIG. 10 illustrates a basic structural type of a DualSteer device, according to an embodiment of the present disclosure.

Referring to FIG. 10, the DualSteer device may be implemented in two types, and the structures and features of each type are as follows.

The first type of DualSteer device 1001 may include one user equipment (UE) protocol stack and two subscription permanent identifiers (SUPIs). This method has a resource-efficient structure because it shares a single protocol stack, in which only one connection is made at a time.

In addition, this structure may be suitable for providing basic DualSteer functions while saving resources.

Meanwhile, the second type of DualSteer device 1003 may include two independent UEs (UE1, UE2), in which their respective protocol stacks and individual SUPIs (SUPI1, SUPI2) are present. This method provides a complete redundancy structure and may connect to two networks simultaneously through independent communication functions. This characteristic may ensure flexibility and high availability in a multi-access environment.

The present disclosure includes both of these implementation methods, and may select and use an implementation method suitable for a specific situation.

FIG. 11 illustrates a DualSteer device convergence function (DCF) implementation structure of a DualSteer device, according to an embodiment of the present disclosure. Specifically, FIG. 11 may provide a structure that is capable of being applied to a first type of DualSteer device and a second type of DualSteer device, as an implementation method of the DualSteer device convergence function (DCF).

Referring to FIG. 11, the first type of DualSteer device 1101 may include a DualSteer device convergence function (DCF), a single user equipment (UE) protocol stack, and SUPI1 and SUPI2. The DCF manages SUPI1 and SUPI2 in a single protocol stack to enable DualSteer functions to be performed within a single UE. This structure is resource-efficient and may be suitable for a single access environment.

The second type of DualSteer device 1103 may include a DCF, two independent UEs (UE1, UE2), and a protocol stack corresponding to each UE. The DCF performs coordination between the two independent UEs and may manage distributed resources in an integrated manner by linking with each protocol stack. This structure is designed in such a manner as to enable simultaneous access to two networks, thereby providing flexibility and high availability.

The DCF may perform the following common functions in both structures:
(1) Management of registration status of SUPI1 and SUPI2 and selection of SUPI to be used for traffic
(2) Coordination of access network selection
(3) Sharing and application of DualSteer policy
(4) Traffic steering and switching control

The DCF implementation structure proposed in this disclosure is designed in such a manner as to provide consistent DualSteer services even in various forms of DualSteer devices.

### Multi Access Example 1

FIG. 12 illustrates a first example of multi-access, according to an embodiment of the present disclosure. Specifically, FIG. 12 illustrates a multi-access structure in a single communication network, in which the structure may include a connection relationship between a multi-access device and multiple network components.

Referring to FIG. 12, the multi-access device may include two subscriber identifiers, SUPI1 1201 and SUPI2 1203. Each SUPI may be independently connected to an RAN1 1205 and an RAN2 1207, and the RAN1 1205 and the RAN2 1207 may be connected to the same core network (CN0) 1209. The core network (CN0) 1209 may act as a home network (HPLMN) of SUPI1 1201 and SUPI2 1203, which results in supporting access to the data network (DN) 1211.

The structure of FIG. 12 enables multiple accesses through different RANs in a single core network, as a basic DualSteer service scenario for supporting multi-access within a single operator's network.

### Multi Access Example 2

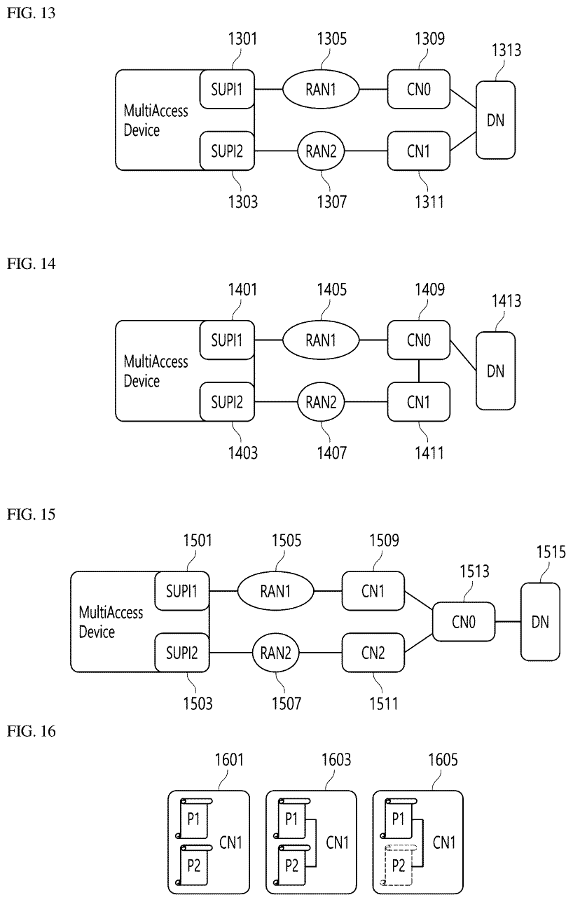

FIG. 13 illustrates a second example of multi-access, according to an embodiment of the present disclosure. Specifically, FIG. 13 illustrates a multi-access structure of a Multi Access device through a wireless access network (RAN) belonging to different communication networks according to an embodiment of the present disclosure, in which such a structure may support networks of various communication service providers.

Referring to FIG. 13, the Multi Access device may include two subscriber identifiers, referred to as SUPI1 1301 and SUPI2 1303. The SUPI1 1301 may be connected to a CN0 1309 through RAN1 1305, and the SUPI2 1303 may be connected to a CN1 1311 through RAN2 1307. The CN0 1309 and the CN1 1311 each represent separate core networks, and such two core networks may be interconnected with the same data network (DN) 1313.

The CN0 1309 may operate as a home network (HPLMN) of SUPI1 1301 and SUPI2 1303, and the CN1 1311 may operate as a visited PLMN of SUPI1 1301. Such a structure may support interoperability between various networks, and provide flexibility to process data through different RANs and core networks.

The present disclosure may provide an optimal data transmission path by utilizing different communication service provider networks in a multi-access environment.

### Multi Access Example 3

FIG. 14 illustrates a third example of multi-access, according to an embodiment of the present disclosure. Specifically, FIG. 14 describes a multi-access structure of a multi-access device via a wireless access network (RAN) belonging to different communication networks, in which this structure may include a hierarchical interconnection method.

Referring to FIG. 14, the multi-access device may include two subscriber identifiers, referred to as SUPI1 1401 and SUPI2 1403. The SUPI1 1401 may be connected to CN0 via an RAN1 1405, and the SUPI2 1403 may be connected to a CN1 1411 via an RAN2 1407. Herein, the CN1 1411 may additionally be connected to a CN0 1409, and all traffic may be finally transmitted to a data network (DN) 1413 via the CN0 1409.

The CN0 1409 may operate as a home network (HPLMN) of the SUPI1 1401 and the SUPI2 1403, and the CN1 1411 may operate as a visited PLMN of SUPI 21403. Unlike the parallel linkage method presented in FIG. 13, this structure may include a hierarchical linkage method in which the second core network (CN1) connects to the DN through the first core network (CN0).

The present disclosure of FIG. 14 may support efficient data transmission in various multi-access environments through a traffic transfer structure between different core networks.

### Multi Access Example 4

FIG. 15 illustrates a fourth example of multi-access, according to an embodiment of the present disclosure.

Referring to FIG. 15, FIG. 15 specifically describes a structure in which a multi-access device connects to a data network (DN) through a wireless access network (RAN) belonging to different communication networks, which may include a structure of a hierarchically linked core network.

The multi-access device may include two subscriber identifiers, SUPI1 1501 and SUPI2 1503. The SUPI1 1501 may be connected to a CN1 1509 via an RAN1 1505, and the SUPI2 1503 may be connected to a CN2 1511 via an RAN2 1507. The CN1 1509 and the CN2 1511 each represent separate intermediate core networks, in which such two core networks may ultimately be connected to a DN 1515 via a central core network (CN0) 1513.

The CN0 1513 may operate as a home network (HPLMN) of SUPI1 1501 and SUPI2 1503, the CN1 1509 may operate as a visited PLMN of the SUPI1 1501, and the CN2 1511 may operate as a visited PLMN of the SUPI2 1503. Such a structure may include a hierarchical interconnection method in which two different visited networks are connected to a data network through a single home network.

Referring to FIG. 15, the present disclosure may support efficient interconnection between various telecommunications service provider networks by optimizing traffic transfer between multiple visited networks and home networks in a multi-access environment.

### Example 1 of Subscription Information Management

FIG. 16 illustrates an example of subscription information management for multi-access in a single communication network. Specifically, FIG. 16 proposes three methods for managing subscriber data P1, P2 of SUPI1 and SUPI2 included in a multi-access device within a single communication network.

Referring to FIG. 16, the first method 1601 allows the subscriber data P1 and P2 to be stored and managed independently, as an independent management method. This method allows both the data to have completely separate structures and to be managed individually within CN1.

The second method 1603 allows the data P1 and P2 to be stored separately while maintaining linkage each other through cross-reference, as a cross-reference method. According this method, it is suitable when data linkage is required, and MSIN, NAI, TMSI, or SUPI, SUCI, GUTI, GPSI, etc. are used as reference information.

The third method 1605 allows the overlapping data to be minimized between P1 and P2, as a duplication minimizing method, in which data is defined only for the P1, and the P2 may refer to information of the P1. This method may increase the efficiency of data management to provide a structure that is easy to maintain consistency.

The present disclosure enables efficient subscription information management according to network conditions and requirements within a single communication network, which may be utilized by selecting an appropriate method.

### Example 2 of Subscription Information Management

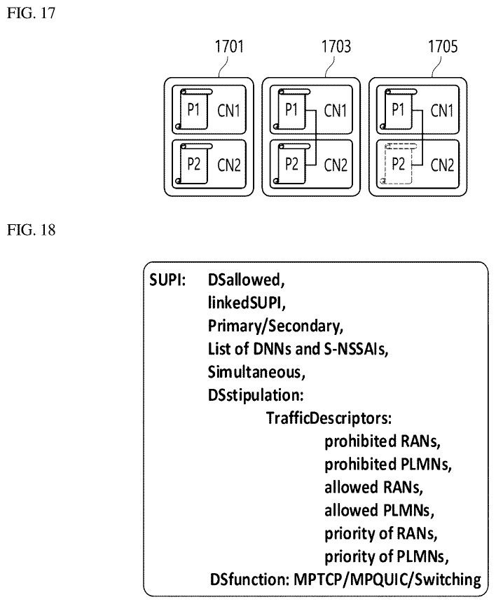

FIG. 17 illustrates an example of subscription information management for multi-access in two communication networks, according to an embodiment of the present disclosure. Specifically, FIG. 17 proposes three methods for managing subscriber data P1 and P2 of SUPI1 and SUPI2 included in a multi-access device in two communication networks.

The first method 1701 allows the data P1 and P2 to be stored and managed independently, respectively, as an independent management method. According to this method, both the data may have completely separate structures and be individually managed in CN1 and CN2, respectively.

The second method 1703 allows the data P1 and P2 to be stored separately while maintaining linkage through cross-reference, as a cross-reference method. This method is suitable when data linkage is required, and as reference information, MSIN, NAI, TMSI, or SUPI, SUCI, GUTI, and generic public subscription identifier (GPSI) may be used.

The third method 1705 allows duplicating data to be minimized between P1 and P2, as a duplication minimizing method, in which data is defined for the P1, and the P2 may refer to information of the P1. This method may provide a structure that is easy to maintain consistency and improve the efficiency of data management.

According to FIG. 17, the present disclosure enables efficient management of subscription information according to network conditions and requirements within two communication networks, which may be utilized by selecting an appropriate method.

### Example of Subscription Information

FIG. 18 illustrates an example of subscription information related to DualSteer, according to an embodiment of the present disclosure. Specifically, FIG. 18 describes the structure of subscription information related to DualSteer for one SUPI in the form of a schema, which may be configured with elements for defining detailed settings and policies for each subscriber.

Referring to FIG. 18, basic information may include at least one of DSallowed indicating whether to subscribe to the DualSteer service, linkedSUPI indicating another linked SUPI, and information distinguishing primary or secondary role of the SUPI.

Referring to FIG. 18, FIG. 18 may record information related to the DualSteer service for one subscription permanent identifier (SUPI). DSallowed indicates whether the SUPI is subscribed to the DualSteer service and provides information on whether to support DualSteer. linkedSUPI indicates a linked SUPI that uses the DualSteer service together with this SUPI in the DualSteer device, and may also be expressed as associated SUPI.

In addition, FIG. 18 may additionally indicate one or more of the following pieces of information for the SUPI: The primary/secondary attribute indicates whether the SUPI operates as a primary or a secondary, and may not specify the distinction between primary and secondary, as necessary. A list of data network names (DNNs) and single network slice selection assistance information (S-NSSAIs) include a list of DNNs and S-NSSAIs that may provide the DualSteer service. When this list is not specified, it may be set to provide service for a specific DNN and S-NSSAI, or to provide service for all DNNs and S-NSSAIs. The simultaneous attribute indicates whether the corresponding SUPI and linkedSUPI may transmit traffic simultaneously, and when this attribute is not specified, it may be implicitly assumed to not support or to support simultaneous transmission.

DSstipulation is a name used for convenience of explanation to indicate policy-related information for the DualSteer service, and is not limited to that name. DSstipulation may include the following information via TrafficDescriptors: prohibited RANs and PLMNs, allowed RANs and PLMNs, and their priorities. Herein, such properties may be set differently for each TrafficDescriptor. In addition, the PLMNs and the RANs may include additional details related to them, and TrafficDescriptors may be indicated for all traffic. Only one or more of the properties of prohibited RANs and PLMNs, allowed RANs and PLMNs, and their priorities may be used.

DSfunction attribute defines how to treat DualSteer traffic, and may include one or more of multipath TCP (MPTCP), multipath quick UDP internet connection (MPQUIC), and switching. MPQUIC may be further subdivided into MPQUIC-UDP, MPQUIC-IP, and MPQUIC-Ethernet. The switching is defined as session switching or traffic flow switching between two accesses. If DSfunction is not specified, only the implicitly predefined DSfunctions may be used.

SUPI and linkedSUPI are used as keys to identify subscription information, one of MSIN, NAI, and TMSI may be used within a single communication network, and one of SUPI, SUCI, GUTI, and GPSI may be used as a universal identifier. Such subscription information may be managed and stored in UDM or UDR of 5G network, and some or all of the subscription information may be maintained identically in the DualSteer device. Some part of the subscription information may be provided through network function elements of 5G network, and may be delivered to the DualSteer device through at least one of the registration procedure, UE configuration update procedure, PDU session establishment procedure, or PDU session modification procedure. In the registration procedure, the AMF provides the subscription information; in the UE configuration update procedure, the PCF provides the subscription information via the AMF; and in the PDU session establishment and PDU session modification procedures, the SMF provides the subscription information via the AMF.

### Example of Service Traffic Information

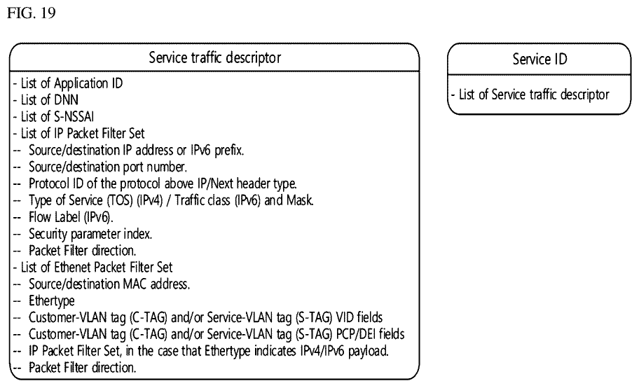

FIG. 19 illustrates an example of service traffic information, according to an embodiment of the present disclosure. Specifically, FIG. 19 illustrates an example of traffic descriptors used in FIG. 18, which includes an example for specifying specific service traffic to which steering and switching will be applied.

Referring to FIG. 19, the service traffic descriptor of FIG. 19 describes characteristics of service traffic, and may simply indicate service traffic through an identifier called service ID by configuring one or more descriptors as a list. The service traffic descriptor may identify service traffic using at least one of Application ID, DNN, S-NSSAI, or packet flow descriptions.

The packet flow descriptions may include one or more of IP packet filter set and ethernet packet filter set. Application ID indicates an ID that identifies an application. DNN indicates data network name that the service will use, and S-NSSAI indicates network slice that the service will use. IP packet filter may include one or more of the following: source or destination IPv4 address and IPv6 prefix, source or destination port number, protocol identifier, IPv4 service type or IPv6 traffic class and flow label, security parameter index, and packet filter direction. When steering or switching is performed on UE side, the destination address and port are mainly used, but in networks that support steering and switching, the source address and port may also be used together.

The Ethernet packet filter may include at least one of: a source MAC address, a destination MAC address, an EtherType, a VLAN identifier (VID) of a customer VLAN TAG (C-Tag) or a service VLAN TAG (S-Tag), a priority code point (PCP)/drop eligible indicator (DEI) of a C-Tag or an S-Tag, and a direction of the packet filter. When the Ethernet packet contains an IP packet again, an IP packet filter may be additionally included.

The IP packet filter and Ethernet packet filter may be described in the form of flow-description attribute value pair (AVP) based on standards such as IETF RFC6733, TS 29.212, and TS 29.214. Such a structure allows a specific service traffic to be accurately identified and steering and switching policies to be applied.

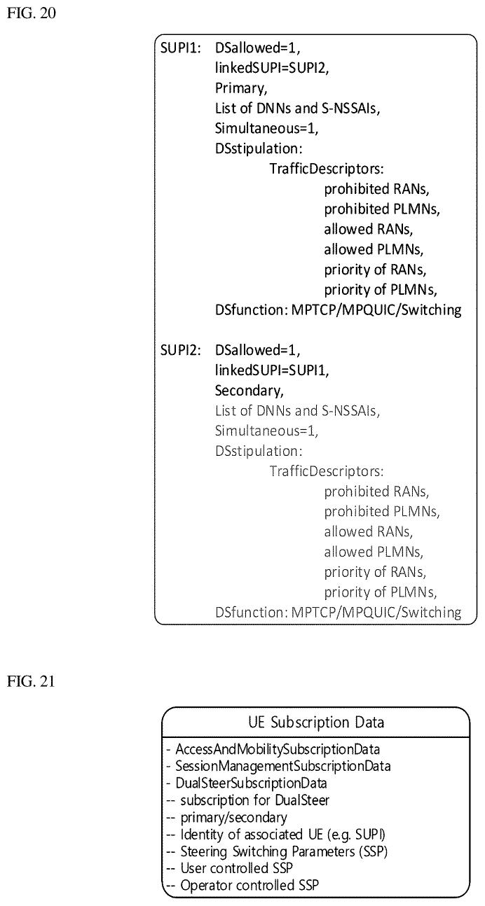

FIG. 20 illustrates an example of subscription information, according to an embodiment of the present disclosure. Specifically, FIG. 20 illustrates an example based on the subscription information of FIG. 19. FIG. 20 illustrates a case where SUPI1 and SUPI2 provide DualSteer service in a single DualSteer device.

Referring to FIG. 20, the SUPI1 and SUPI2 may indicate that they may support the DualSteer service by setting whether to use the DualSteer service (DSallowed) to 1. The two SUPIs designate each other as linkedSUPIs, so that the SUPI1 may indicate the SUPI2 as a linked SUPI, and the SUPI2 may indicate the SUPI1 as a linked SUPI.

Each SUPI has a distinct role by a primary/secondary attribute. When the SUPI1 is set to primary, the SUPI2 may be set to secondary, whereas when the SUPI2 is set to primary, the SUPI1 may be set to secondary.

In addition, List of DNNs and S-NSSAIs, Simultaneous, DSstipulation, and DSfunction which are required for the DualSteer service may have the same values for both SUPI1 and SUPI2. This same information may be recorded in each of the SUPI1 and SUPI2, or may be described only in one of the SUPIs linked to linkedSUPI and omitted in other SUPIs.

The SUPI1 and SUPI2 may indicate TrafficDescriptors through DSstipulation of each SUPI, and may include prohibited RANs and PLMNs, allowed RANs and PLMNs, and priorities for them (priority of RANs and priority of PLMNs). DSfunction attribute supports one or more DualSteer traffic processing methods among MPTCP, MPQUIC, and Switching, and in the case of Switching, session switching or traffic flow switching may be used.

Such a structure allows for efficient linkage and consistent service policy application between the SUPI1 and the SUPI2 in the DualSteer device, and allows implementation of service traffic management and DualSteer functions to be efficiently performed.

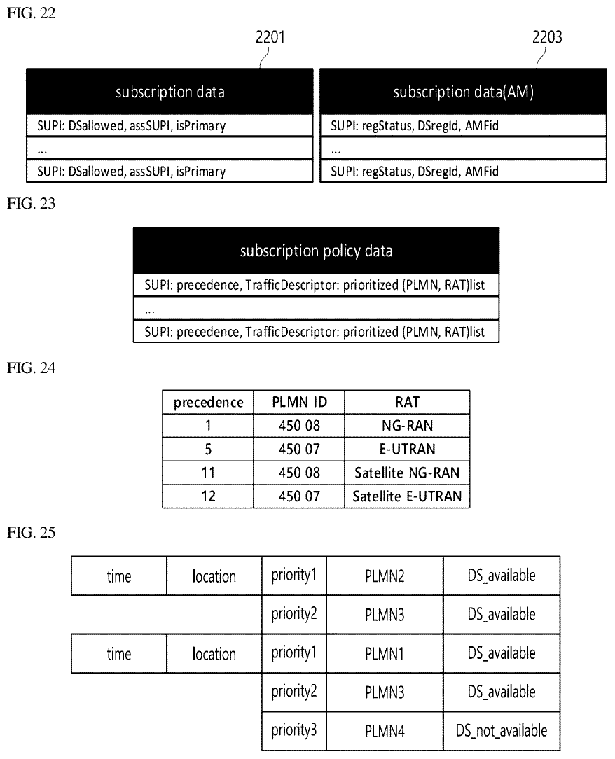

FIG. 21 illustrates another example of subscription information, according to an embodiment of the present disclosure. Specifically, FIG. 21 illustrates DualSteerSubscriptionData for DualSteer service of MASS services.

Referring to FIG. 21, components of DualSteerSubscriptionData may include at least one of the following information elements: subscription for DualSteer may indicate whether the corresponding UE is subscribed to the DualSteer service. Primary/secondary may indicate whether the subscription data is primary or secondary, and may be configured so that corresponding information is described for only primary information among subscriber data and secondary information may be set to refer to the primary information, as described in FIG. 16 and FIG. 17. Identity of associated UE may indicate linkedSUPI, and may include linked SUPI information for providing the DualSteer service.

Steering switching parameters (SSP) include information required for steering and switching in the subscription information of this UE, and various embodiments thereof are illustrated in FIGS. 24 to 28. The SSP may be divided into user-controlled SSP and operator-controlled SSP. The user controlled SSP may include SSP information set by the user, and the operator controlled SSP may include SSP information set by a network operator. The network operator may be a visiting PLMN (VPLMN) operator where the UE is located, a home PLMN (HPLMN) operator, or a non-public network (NPN) operator. The NPN operator may be divided into public network integrated NPN (PNI-NPN) which is based on PLMN and standalone NPN (SNPN) which is an independent private network.

In particular, in the SSP setting, either the user-controlled SSP or operator-controlled SSP may be set as a priority, in which the priority may be set according to conditions. For example, it may be determined whether the user setting or operator setting will be given priority depending on a specific network situation.

The information contained in DualSteerSubscriptionData may exist separately from AccessAndMobilitySubscriptionData or SessionManagementSubscriptionData. However, if necessary, DualSteerSubscriptionData may be contained in either AccessAndMobilitySubscriptionData or SessionManagementSubscriptionData, or stored and used separately in these data.

Such structure enables systematic management of subscriber-specific settings and policies for DualSteer services, and may support efficient cooperation between users and network operators.

### [Example of AM Subscription Data Among Subscription Information]

FIG. 22 illustrates an example of AM subscription data among subscription information, according to an embodiment of the present disclosure. Specifically, FIG. 22 illustrates an example showing a part related to DualSteer Access and Mobility (AM) among various parameters defined in FIG. 18. FIG. 22 describes a structure in which existing AM subscription data is extended to support DualSteer service.

Referring to FIG. 22, subscription data 2201 may include at least one of the following three main pieces of information about SUPI. DSallowed indicates whether to subscribe to DualSteer service, which corresponds to DSallowed of FIG. 18. assSUPI includes related SUPI information, which corresponds to linkedSUPI of FIG. 18. isPrimary distinguishes the role of SUPI by indicating whether it is primary or secondary, which may correspond to the primary/secondary attribute of FIG. 18.

Subscription data (AM) 2203 may additionally include at least one of the following information extended for the SUPI subscribed to the DualSteer service: regStatus indicates the 5G core network (5GCN) registration status of the corresponding SUPI. DSregId may provide a unique identifier related to the DualSteer service, as a DualSteer registration identifier defined in FIG. 22. AMFid indicates the identifier of an access and mobility management function (AMF) to which the SUPI is registered, which may be an item already included in the existing AM subscription data.

The subscription data and the AM subscription data may be managed in an integrated manner or managed independently, depending on the embodiment. Such a structure allows the existing AM subscription data to be extended to meet the DualSteer service requirements, thereby efficiently managing the registration status and identifier information.

### [Example of Policy Subscription Data of Subscription Information]

FIG. 23 illustrates an example of policy subscription data of subscription information, according to an embodiment of the present disclosure. FIG. 23 shows a part related to the DualSteer policy (subscription policy data) of various parameters of the Subscription Data, which may explain the policy configuration which is applicable to each SUPI.

Referring to FIG. 23, the subscription policy data may be configured in such a manner to define the policy for each SUPI. The main components may include at least one of SUPI, precedence, TrafficDescriptor, and prioritized (PLMN, RAT) list. The SUPI is information that identifies a subscriber, and precedence may indicate a policy priority for the subscriber. The TrafficDescriptor is based on the traffic identification information defined in FIG. 19, and describes specific characteristics of service traffic. The prioritized (PLMN, RAT) list is a list that defines the priorities of public land mobile network (PLMN) and radio access technology (RAT).

The policy illustrates an example of a priority-based policy among prohibited/allowed/priority described in FIG. 18. This structure provides different guidelines for each SUPI according to a specific TrafficDescriptor, to allow for more detailed priority settings for PLMN and RAT.

This structure provides detailed policies for PLMN and RAT selection for specific service traffic, and supports more sophisticated policy application and management in DualSteer services.

### [Example of PLMN/RAT Combination Information and Priorities]

FIG. 24 illustrates an example of PLMN/RAT combination information and priorities, according to an embodiment of the present disclosure. Specifically, FIG. 24 illustrates an example of the prioritized (PLMN, RAT) list defined in FIG. 23. FIG. 24 may explain a method of defining priorities based on combination information of PLMN and RAT.

Referring to FIG. 24, a combination of PLMN ID and RAT is configured as a priority list, and each combination may indicate a priority to be applied to a specific service. For example, the following priorities may be included:

Priority 1 may be a combination where PLMN ID is 450 08 and RAT is NG-RAN, priority 2 may be a combination where PLMN ID is 450 07 and the RAT is E-UTRAN, priority 3 may be a combination where the PLMN ID is 450 08 and the RAT is Satellite NG-RAN, and priority 4 may be a combination where the PLMN ID is 450 07 and the RAT is Satellite E-UTRAN.

This priority list is used in an order defined for specific service traffic, and may provide network selection criteria. In addition, this structure is extensible so that the priority policy may further refined by including additional elements, such as frequency information, altitude information, or private network-related information mentioned in FIG. 7. This allows for flexible priority policy setting considering various network characteristics and requirements.

### [An Embodiment of DualSteer Policy]

FIG. 25 illustrates a first example of DualSteer policy, according to an embodiment of the present disclosure. Specifically, FIG. 25 illustrates another example of the prioritized (PLMN, RAT) list defined in FIG. 23 which is extended to DualSteer policy. FIG. 25 illustrates a network selection policy by combining PLMN and DualSteer service availability information based on time and location.

Referring to FIG. 25, DualSteer policy provides steering and switching guidance information for PLMN and RAT of service traffic, and may be used by modifying or in combination with the existing steering of roaming (SoR) or UE route selection policy (URSP).

FIG. 25 may be configured according to two time/location combinations. In the first time/location combination, PLMN2 (DS_available) is set to priority1, and PLMN3 (DS_available) is set to priority2. In the second time/location combination, PLMN1 (DS_available) may be set to priority1, PLMN3 (DS_available) to priority2, and PLMN4 (DS_not_available) to priority3.

This policy may identify PLMNs by MCC, MNC, MNO_ID, or MNO_NAME, to provide flexibility to apply priority according to the list order when time information, location information, DS_available or DS_not_available status may be omitted, or priority may be omitted, as necessary. Here, DS_available and DS_not_available are information on whether Dual-steer connection is possible according to time and location, and may be used especially effectively when the access network is a satellite (NTN).

Steering of roaming (SoR) which is a technical background of DualSteer policy is a PLMN selection technology of roaming UEs, to select a preferred PLMN by utilizing priority information and PLMN identifier provided by HPLMN. The UE route selection policy (URSP) is a policy that selects an optimal path based on service traffic, to optimize path selection by including access type (3GPP, non-3GPP, multi-access), traffic descriptor, and connection parameters. At least one of SOR, URSP or DualSteer policy may indicate that the second SUPI's access network is connected to an access network other than the first SUPI's access network. Herein, the second access network must have a different RAT from the first access network, in which the RAT may be at least one of the types of RANs and PLMNs described in Table 1.

Such structure may flexibly apply PLMN selection policy according to time and location, and may support optimization of user service environment including DualSteer service availability (DS_available/DS_not_available).

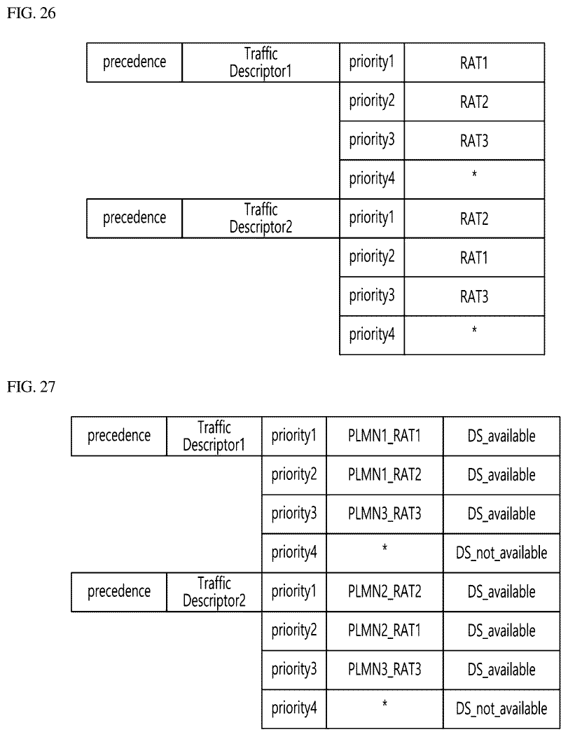

FIG. 26 illustrates a second example of DualSteer policy, according to an embodiment of the present disclosure. Specifically, FIG. 26 shows an example of URSP-based DualSteer policy, and provides a detailed RAT selection policy according to traffic characteristics.

Referring to FIG. 26, the DualSteer policy may be configured based on Traffic Descriptors. The precedence of the first traffic descriptor indicates a priority value, and traffic descriptor1 indicates a specific traffic identifier. The RAT priority is defined by setting RAT1 for priority1, RAT2 for priority2, RAT3 for priority3, and “*” for priority4. “*” includes all RATs or indicates a RAT that is applicable by default.

The precedence of the second Traffic Descriptor also indicates the priority value, in which Traffic Descriptor2 indicates another traffic identifier. In this case, the RAT priority is defined by setting RAT2 for priority1, RAT1 for priority2, RAT3 for priority3, and “*” for priority4.

The Traffic Descriptor refers to the format defined in FIG. 19, and may be integrated with existing URSP information. In addition, precedence specifies the priority between Traffic Descriptors, and priority specifies the priority order of each RAT. The precedence and priority may be omitted, in which the order of the list replaces the priority.

Another example may be expressed in the opposite form of FIG. 26. A DSregId may be used to specify an access network, instead of (priority, RAT) combination, for a Traffic Descriptor.

This structure enables the implementation of a detailed RAT selection policy according to traffic characteristics, to allow for flexible and efficient network selection and resource management in the DualSteer service.

FIG. 27 illustrates a third example of DualSteer policy, according to an embodiment of the present disclosure. Specifically, FIG. 27 illustrates an example of DualSteer policy by integrating Steering of Roaming (SoR) and UE route selection policy (URSP).

The structure of FIG. 25 provides a comprehensive policy based on the combination information of PLMN and RAT and the availability of DualSteer service.

Referring to FIG. 27, the basic configuration of DualSteer policy includes precedence, PLMN_RATcombo, and DS_available attributes. The precedence indicates the priority between Traffic Descriptors, and the PLMN_RATcombo indicates a combination of PLMN and RAT. The DS_available attribute defines whether the DualSteer service is available in the corresponding combination.

In the example of Traffic Descriptor1, the following priorities are set:
priority1: PLMN1_RAT1 (DS_available)
priority2: PLMN1_RAT2 (DS_available)
priority3: PLMN3_RAT3 (DS_available)
priority4: *(DS_not_available)

In the example of Traffic Descriptor2, the following priorities are set:
priority1: PLMN2_RAT2 (DS_available)
priority2: PLMN2_RAT1 (DS_available)
priority3: PLMN3_RAT3 (DS_available)
priority4: *(DS_not_available)

In this structure, the PLMN is identified by MCC, MNC, MNO_ID, MNO_NAME, and may also utilize the PLMN reference number of SoR. The RAT information may include frequency band information if necessary.

Components of Traffic Descriptor may include at least one of Application ID, IP destination information (IP descriptors), domain identification information (domain descriptors), non-IP network information (non-IP descriptors), data network name (DNN), network connection capabilities, Personal IoT Network identifier (PIN ID), and 5G-RG group identifier (connectivity group ID).

The DualSteer policy configures the final policy considering both operator-controlled DualSteer policy (provided by HPLMN) and user-controlled DualSteer policy (user setting). The priorities of the two policies are set according to the situation, thereby providing a comprehensive DualSteer policy framework that combines the advantages of SOR and URSP.

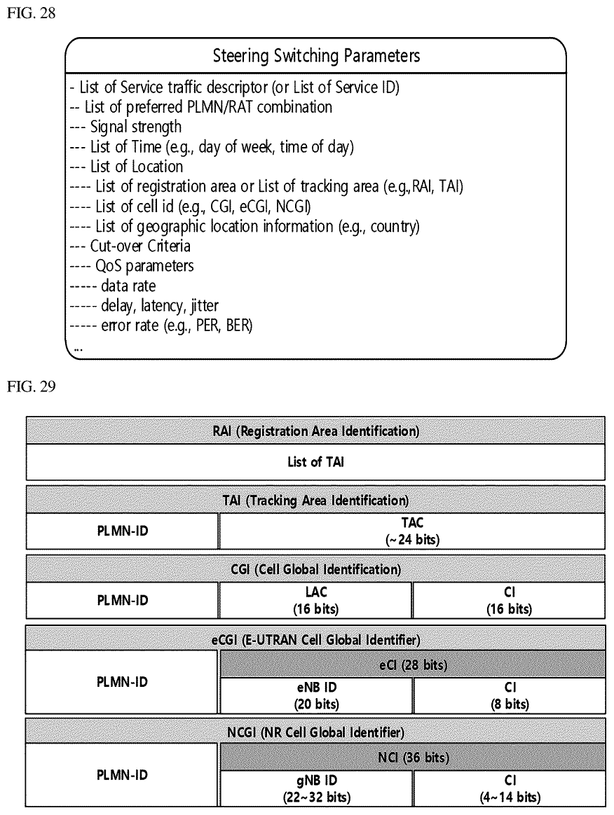

FIG. 28 illustrates a fourth example of DualSteer policy, according to an embodiment of the present disclosure. Specifically, FIG. 28 illustrates an example of SSP of FIG. 21. The DualSteer policy provides guidance information for steering or switching service traffic to a specific PLMN and RAT, and may be used by modifying or in combination with existing Steering of Roaming (SoR) or UE route selection policy (URSP).

Referring to FIG. 28, FIG. 28 may specify the traffic in a list of service traffic descriptors provided for a specific SUPI, using the service traffic descriptor of FIG. 19.

Instruction is made to steer and switch to one or more PLMN/RAT combinations for the specified service traffic. The list of preferred PLMN/RAT combinations indicates a combination of PLMNs and RATs using at least one of the types of RAN and PLMNs described in Table 1.

Another example may use List of DSregId(s) instead of List of preferred PLMN/RAT combination.

The conditions for steering and switching specific service traffic to a specific PLMN/RAT or DSregId may further include at least one of signal strength, time, location, and other conditions (cut-over criteria).

The signal strength from the PLMN/RAT may be specified, such that when the signal strength from the PLMN/RAT is above a certain level, it steers or switches to the PLMN/RAT, and when it is below a certain level, it may be prevented from using the PLMN/RAT.

It is possible to specify steering or switching to the corresponding PLMN/RAT at a certain time. The PLMN/RAT may be used during a specified time and the PLMN/RAT may not be used outside of the specified time. The time may be further specified by date, day of the week, etc., and at least one of which may be used so that a range may be indicated by using two or more values for each of them.

Steering or switching to the corresponding PLMN/RAT may be specified at a certain location. The PLMN/RAT may be used while at the specified location and the PLMN/RAT may be not used at other locations. Referring to FIG. 29, the location may be indicated using list of registration area or list of tracking area with tracking area identification (TAIs) using PLMN id and tracking area code or registration area identification (RAI) composed of one or more TAI. Alternatively, the location may use one or more of cell global identification (CGI) using PLMN id and location area code (LAC) and cell identification (CI), E-UTRAN CGI (eCGI) using PLMN id and eNB ID and cell ID, or NR CGI (NCGI) using PLMN id and gNB ID and cell ID as a list. Alternatively, the location may be indicated by location information using GPS, etc.

As other conditions, QoS parameters may be representatively used. When a PLMN/RAT may not satisfy a certain QoS, steering or switching to another PLMN/RAT may be specified. The QoS parameters used may be data rate, delay, latency, jitter, or error rate. The QoS parameters may be values measured directly by the UE or QoS parameters received from the network. The network may measure QoS parameters such as data rate, delay, latency, jitter, or error rate in the corresponding PLMN/RAT to assist steering and switching of the UE.

Data rate may be defined according to various sections such as between UE and RAT, between UE and PSA UPF, between UE and application server, etc. Delay and latency are also defined according to various sections such as between UE and RAT, between UE and PSA UPF, between UE and application server, etc., and may be defined as unidirectional or bidirectional. Jitter may also be defined according to various sections such as between UE and RAT, between UE and PSA UPF, between UE and application server, etc. A error rate may include packet error rate, bit error rate, etc.

Some of the parameters may be selectively used, or other parts may be combined. In addition, the parameters may be used as a combination of AND or OR.

The DualSteer policy may apply one or more of the policies (operator-controlled DualSteer policy) provided by HPLMN, and the policies (user-controlled DualSteer policy) set by the user. The final DualSteer policy is configured considering priorities between the policies provided by HPLMN and the policies set by the user, which allows for efficient network selection and traffic management.

### [Example of Location Information]

FIG. 29 illustrates an example of information display for a location of FIG. 28, according to an embodiment of the present disclosure. Specifically, FIG. 29 illustrates a structure of various location identifiers used in a network as an example of displaying Location information illustrated in FIG. 28.

Referring to FIG. 29, FIG. 29 defines location information such as RAI, TAI, CGI, eCGI, NCGI, etc., and may be utilized for location-based policy application of DualSteer service.

A registration area identification (RAI) may include one or more tracking area identifications (TAIs). A TAI consists of a PLMN ID and a Tracking Area Code (TAC), and a PLMN ID may follow the structure defined in FIG. 1. A cell global identification (CGI) may include a PLMN ID, a location area code (LAC), and a cell identification (CI). E-UTRAN CGI (eCGI) may include PLMN ID, eNB ID (20 bits), and CI (8 bits), and NR cell global identifier (NCGI) may include PLMN ID, gNB ID (22-32 bits), and CI (4-14 bits).

In addition, when using GPS, one or more values of longitude, latitude, and altitude may be utilized to indicate a location. A specific range may be specified using more than two values for each element, so that more detailed location information may be defined.

The structure of FIG. 29 may allow the location information to be managed and applied in detail in network policy design for the DualSteer service.

According to various embodiments of the present disclosure, an example of a DualSteer rule may represent the structure of a rule that defines DualSteer RAT preference for a specific application. According to this rule, network resources may be efficiently utilized by setting RAT and PLMN preferences segmented for each application based on traffic descriptor (see FIG. 19).

DualSteer RAT preference may be configured in the form of a list of preference elements. Each preference element indicates conditions and priorities to be applied in the DualSteer Rule, and may include one or more of the following elements.

(1) Precedence: indicates the priority, which is the criterion for determining the preference when multiple conditions are applied.

(2) RAT priority: defines the preference order for a radio access technology (RAT).

(3) PLMN priority: defines the preference order for a public land mobile network (PLMN).

(4) PLMN_RAT priority: defines the preference order for a combination of PLMN and RAT.

Such a structure allows the DualSteer rule to implement a network connection policy customized for each application. The rule may be flexibly set according to the network environment and application requirements, and may support optimal network resource allocation and improved user experience.

### [Example of DualSteer Rule]

### [Example of PCC Rule]

Table 2 illustrates an example of a PCC rule, according to an embodiment of the present disclosure. Specifically, Table 2 may provide precise priority control for DualSteer connections by including DualSteer access priority in a priority charging and control (PCC) rule.

TABLE 2
Example of PCC Rule

| | |
|---|---|
| O Rule Identifier | Identifier of Rule |
| O Service data flow detection | Specification for traffic |
| | See [FIG. 19] |
| >Precedence | Priority of Service data flow template |
| >Service data flow template | Application ID, |
| | Transmitting IP address, Transmitting |
| | port, Receiving IP address, Receiving port, |
| | Protocol |
| | Specification with Transmitting MAC |
| | address, Receiving MAC address, VLAN tag, |
| | Service VLAN tag, Customer VLAN tag, |
| | EtherType, etc. |
| O MA PDU Session Control | List of Route Selection Description |
| >Application descriptors | Specification for traffic to which steering |
| | functionality will be applied |
| | See [FIG. 19] |
| >Steering Functionality | MPTCP, MPQUIC, ATSSS-LL, |
| | DualSteer |
| >DualSteer Access Priority | RATtype1, RATtype2 (Identifier for |
| | each RAT) |
| | (accessidentifier1, accessidentifier2) |
| | (SUPI1, SUPI2) |
| >Steering Mode | |
| >Steering Mode Indicator | |
| >Threshold Values | |
| >Transport Mode | |
| >Charging key for Non-3GPP | |
| access | |
| >Monitoring key for Non-3GPP | |
| access | |

Referring to Table 2, the DualSteer access priority may be included in MA PDU Session Control of PCC rule, and may include priority information for access network to be used by a UE. In addition, the DualSteer access priority may indicate priority information for access network to be used by the UE for traffic specified by application descriptors.

The priority information for access network may be expressed in various ways. According to an embodiment, the priority information for access network may be indicated by identifier for the corresponding access network and its priority value. The priority may be indicated by value indicating priority such as primary/secondary or by enumeration order of access network identifier.

The access network identifier may use RATtype or an identifier assigned to the corresponding access network, in which the RATtype may include a unique value indicating a network type, such as 5G, LTE, TN, NTN, etc.

According to another embodiment, the priority information for the access network may be indicated using a subscription permanent identifier (SUPI) connected to the corresponding access network. Herein, the priority may be indicated using a SUPI-specific priority value or in the enumeration order of SUPIs connected to the access network.

In addition, the access network priority information may be expressed using one or more of PLMN, radio access technology (RAT), and radio access frequency representing the corresponding access network. Herein, the priority may be indicated using the priority values for PLMN, RAT, or radio access frequency, or in the enumeration order of them.

The DualSteer access priority defined in this way may optimize traffic and access network selection between UE and network, and may contribute to providing efficient network resource management and user experience through the DualSteer service.

### [Example of URSP]

Table 3 illustrates an example of a USRP, according to an embodiment of the present disclosure. Specifically, Table 3 shows a structure that may include DualSteer policy when providing a UE route selection policy (URSP) to a UE. The HPLMN may provide priority information for an access network by including DualSteer access priority in route selection descriptors of the URSP.

Referring to Table 3, according to an embodiment, multi-access or DualSteer may be specified in access type preference of the URSP, and priority information for the corresponding Access network may be included in the DualSteer access priority. Herein, the priority information of the access network may be indicated in the following manner:

### (1) Access Network Identifier-Based Representation

The priority may be expressed by using the identifier for the access network and its priority value, or through the enumeration order of identifiers.

### (2) SUPI-Based Representation

The priority may be indicated by using the SUPI connected to the access network. Herein, the priority may be defined by using a SUPI-specific priority value, or through the enumeration order of SUPIs.

### (3) Network Characteristic-Based Representation

The access network may be represented by one or more of PLMN, radio access technology (RAT), and radio access frequency. Herein, the priority may be defined by using the priority values for PLMN, RAT, or radio access frequency, or through their enumeration order. In addition, when the access type preference of the URSP is multi-access or DualSteer, multi-access descriptors may be added to more specifically represent the corresponding access. The multi-access descriptors may use 3GPP & non-3GPP as multi-access for existing ATSSS, and may define the following network combinations as multi-access for DualSteer:
5GNR & LTE
5G_TN & 5G_NTN
5-5G_NTN & LTE

This URSP structure may allow for precise and efficient access network selection and routing for UE traffic through DualSteer policy, and may contribute to optimization of network resources and improved user experience.

TABLE 3
Example of URSP

| | |
|---|---|
| O Rule Precedence | Rule selection priority |
| O Traffic descriptor | Specification for traffic |
| | Specification with Application |
| | descriptors, IP descriptors, Non-IP descriptors, |
| | Domain descriptors, DNN, Connection |
| | Capabilities, PIN ID, Connectivity Group ID, |
| | etc. |
| O List of Route Selection Descriptors | List of Route Selection Description |
| Route Selection Descriptor | Priority of Route Selection Description |
| Precedence | |
| >Route selection components | |
| >>SSC Mode Selection | SSC mode |
| >>Network Slice Selection | S-NSSAI(s). |
| >>DNN Selection | DNN(s). |
| PDU Session Type Selection | PDU Session Type |
| >>Non-Seamless Offload indication | Offloaded to non-3GPP access outside |
| | of a PDU Session. |
| >>Access Type preference | 3GPP or non-3GPP or multi-access or |
| | DualSteer |
| >>multi-access Descriptors | 3GPP & non-3GPP, 5GNR & LTE, |
| | 5G TN & 5G NTN, 5G NTN & LTE . . . |
| >>DualSteer Access Priority | RATtype1, RATtype2 (Identifier for |
| | each RAT) |
| | (accessidentifiyer1, accessidentifier2) |
| | (SUPI1, SUPI2) |
| >>PDU Session Pair ID | ID of Redundant PDU Session |
| >>RSN | Redundancy Sequence Number |
| Route Selection Validation | Time Window or Location Criteria to |
| Criteria | apply |

[Examples of RULEs Separately from USRP]

Table 4 illustrates multi-access selection rules separately from the URSP, according to an embodiment of the present disclosure.

TABLE 4

| | |
|---|---|
| Information name | Description |

O multi-access Selection Rules
>multi-access Selection
Rule
>>precedence
>multi-access

| Selection Validation Criteria | | |
|---|---|---|
| >Time Window | Time | |
| Location Criteria | Location | |
| multi-access | | |
| selection combo | | |
| >>>precedence | | |
| >>>List of descriptors | List of preferred PLMN/RAT combinations of SSPs | |
| | in [FIG. 18a] | |
| >>>>PLMN | PLMN1 | PLMN1 |
| >>>>RAT | 5GNR | LTE |
| >>>Signal strength | Details of SSP in | Details of SSP in |
| >>>>List of Time | [FIG. 18A] | [FIG. 18a] |
| >>>>List of Location | | |
| >>>>Cut-over Criteria | | |

Referring to Table 4, the multi-access selection rules may be provided to the DualSteer device, separately from the URSP. The multi-access selection rules may include at least one of the following: multi-access selection validation criteria define a combination of PLMNs and RATs that may be used at a specific time and location, which may be indicated as a multi-access selection Combo.

The multi-access selection combo may be configured in such a manner to express a combination of PLMNs and RATs as a list and to indicate the priority for each combination. For example, the multi-access selection combo including a combination of PLMN1/5GNR and PLMN1/LTE shows the corresponding example. In multi-access selection combo, PLMN/RAT combination in List of descriptors may be replaced with List of DSregId(s).

In addition, only RAT may be used, excluding PLMN from the multi-access Selection Combo. Herein, selection of the PLMN may be replaced by utilizing the existing steering of roaming (SOR) policy.

Referring to Table 4, the multi-access selection rules may be provided in the registration procedure of the first SUPI, so that the second SUPI may be used to select the PLMN and RAT which to register. In addition, the multi-access selection rules may be provided in advance to the DualSteer device, so that they may be utilized in the registration procedure of the first SUPI.

Referring to Table 4, additional flexibility for multi-access selection may be provided independently from the URSP, thereby supporting efficient utilization of network resources and optimized registration procedures for DualSteer services.

### [Example of UDR Data]

Table 5 illustrates an example of UDR data, according to an embodiment of the present disclosure.

TABLE 5

| Data Set | Data Subset |
|---|---|
| O Application data | Packet Flow Descriptions (PFDs) |
| | AF traffic influence request information for traffic routing |
| | AF traffic influence request information for service function |
| | chaining |
| | Background Data Transfer |
| | Service specific information |
| | EAS Deployment Information |
| | AM influence information |
| | AM influence information |
| | AF request for QoS information |
| | DualSteer RAT preference information |
| | >List of DualSteer RAT preference components |
| | >>DualSteer RAT preference component identifier |
| | >>Precedence |
| | >>List of Traffic Descriptors |
| | >>Ordered list of RAT preference: (e.g., 5G_NR, |
| | 5G_NTN, LTE, . . . ) |

Referring to Table 5, user data repository (UDR) is a database that stores various application data and network policy data, which may further include radio access technology (RAT) preference information of DualSteer service to manage data required for network operation. Data stored in UDR may be basically divided into application data and DualSteer RAT preference information.

The application data may include packet flow management, traffic routing, and service-specific information. Main components of the application data may be packet flow descriptions (PFDs), application function (AF) influence request information for traffic routing, AF request information for service function chaining, background data transfer information, service specific information, edge application server (EAS) deployment information, Access Management (AM) related information, and AF request information for ensuring QoS (Quality of Service). Such data provides the basis required for network policy setting and operation.

In particular, the DualSteer RAT preference information added to support DualSteer service indicates the preference for the network access method (RAT) supported by the DualSteer service. This information is expressed as a list of DualSteer RAT preference components, and each component includes at least one of the DualSteer RAT preference component identifier, precedence, list of traffic descriptors, and RAT preference list (e.g., 5G_NR, 5G_NTN, LTE, etc.), thereby clearly defining which network access method will be preferred for specific traffic. List of DSregId(s) may be used instead of RAT preference list.

The UDR data plays an important role in creating network policy. It is used as basic data when creating PCC Rules or UE route selection policy (URSP), and may consistently provide policy data related to the DualSteer service. This data may be integrated and managed with application data, which results in improving the efficiency and flexibility of network operation.

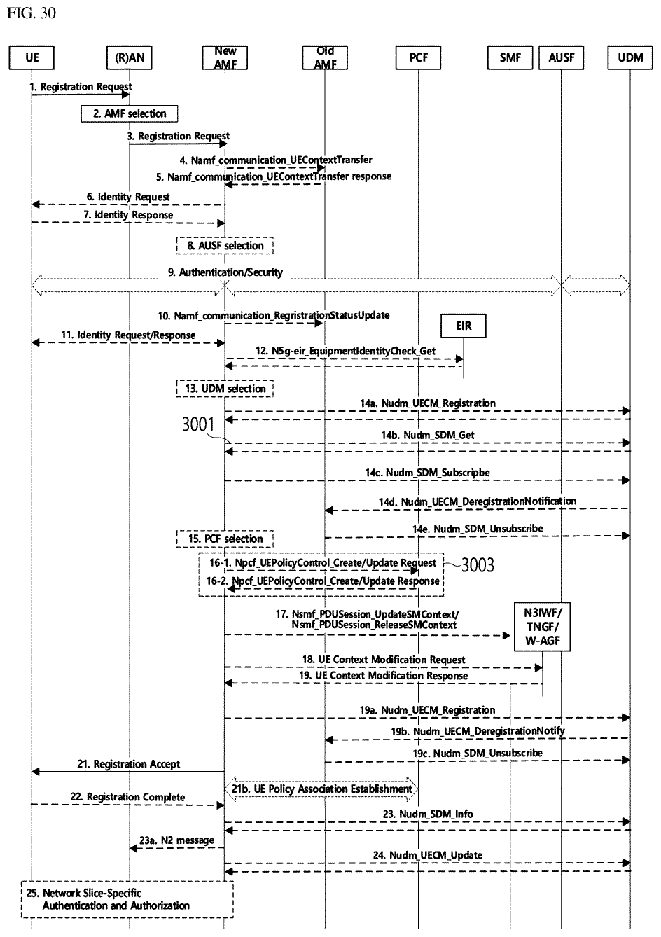

FIG. 30 illustrates the existing UE registration procedure, according to various embodiments of the present disclosure. Specifically, FIG. 30 shows the existing UE registration procedure specified in 4.2.2.2.2 of 3GPP TS 23.502, and describes the process of processing a Registration Request when a UE transmits the same to a 5G network. This process may be extended to cases where the UE is in Home PLMN (HPLMN) and roaming to the Visiting PLMN (VPLMN).

### [Subscription Data Inquiry 3001]

Referring to FIG. 30, when the UE transmits the Registration Request to the HPLMN, the AMF of the HPLMN (H-AMF) may inquire subscription data from the UDM of the HPLMN (H-UDM). Meanwhile, when the UE transmits the Registration Request to the VPLMN, the AMF of the VPLMN (V-AMF) may inquire subscription data from the UDM of the HPLMN (3001). In this way, the UDM of the HPLMN may always be used as the UDM.

### [Policy Inquiry 3003]

Policy inquiry may be processed differently depending on whether the Registration Request is transmitted to the HPLMN or VPLMN. When the UE transmits the Registration Request to the HPLMN, the H-AMF may inquire the policy with the PCF of the HPLMN (H-PCF). Meanwhile, when the UE transmits the Registration Request to the VPLMN, the V-AMF may inquire the policy with the PCF of the VPLMN (V-PCF) (3003). In the operation (3003), the Npcf_UEPolicyControl_Create Request or Npcf_UEPolicyControl_Update Request messages are used, which may mean a new policy setting request or an existing policy update request, respectively. In response to this, the Npcf_UEPolicyControl_Create Response or the Npcf_UEPolicyControl_Update Response may be transmitted.

### [UE Policy Association Processing]

When UE Policy Association for the corresponding UE is not established between the AMF and the PCF, a new policy may be created through Create Request and Create Response messages. When the UE Policy Association is already established, the existing policy may be updated using Update Request and Update Response messages (3003). Such procedure may be processed in both HPLMN and VPLMN environments in the same manner.

FIG. 30 illustrates a process of inquiring and applying subscriber data and policies required for the UE to be seamlessly connected to the network. This process may also be utilized as a basis for supporting advanced network functions such as DualSteer.

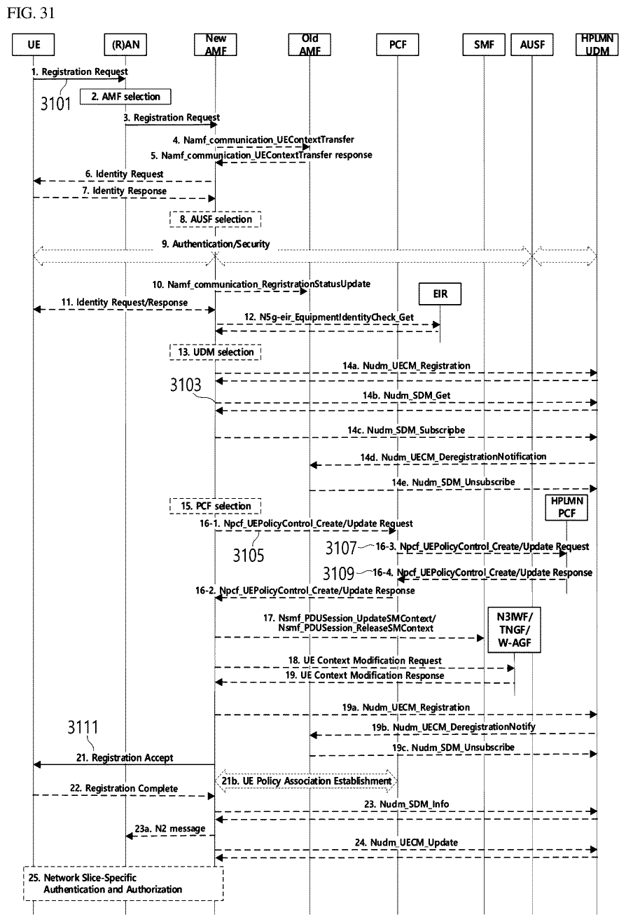

FIG. 31 illustrates the existing UE registration procedure according to various embodiments of the present disclosure. Specifically, FIG. 31 illustrates a process of registering a DualSteer Capable UE in the VPLMN based on the procedure defined in 4.2.2.2.2 of 3GPP TS 23.502. This procedure includes registration processing of UEs supporting DualSteer services, and verification and setting of DualSteer-related policies and authorization information.

Referring to FIG. 31, the UE may transmit a Registration Request message to the AMF 3101. The operation request message of operation 3101 may include DualSteer Capable information of the UE, and may include one or both of the two SUPIs of the DualSteer device.

The AMF may inquire subscription data of the UE from the UDM (3103). In operation 3103, the UDM or AMF may verify authorization for the DualSteer service and confirm whether there is DualSteer Capable. The UDM may perform verify authorization for a request from the AMF including the DualSteer Capable information, or verify authorization for DualSteer of the corresponding UE by referring to subscription data which the AMF receives from the UDM.

The V-AMF may transmit a policy request (Npcf_UEPolicyControl_Create/Update Request) including DualSteer Capability information to the V-PCF (3105).

The V-PCF may request DualSteer related policy information from H-PCF (3107).

The H-PCF may transfer DualSteer related policy to the V-PCF (3109). The operation 3109 may include DualSteer policy including steering/switching information for each PLMN/RAT combination.

The AMF may send registration acceptance message to UE (3111). The operation 3111 may include DualSteer policy. The DualSteer policy may be stored in a UE policy container and may be included in payload container of NAS message.

According to FIG. 31, the H-PCF may inquire DualSteer subscription data from the H-UDM or H-UDR to provide DualSteer service, and transmit policy to the V-PCF based on this. Additionally, when DualSteer policy to be provided to the second SUPI is the same as the policy already provided to the first SUPI, the policy transfer may be omitted, or an optimization function for AMF to manage correlation between SUPIs may be included.

According to FIG. 31, each AMF related to the registration of the first SUPI and the second SUPI of the DualSteer device may manage its registration status, and maintain the session status and correlation between SUPIs. The UDM/UDR may share SUPI registration information between AMFs, and efficiently manage subscription data required for DualSteer service.

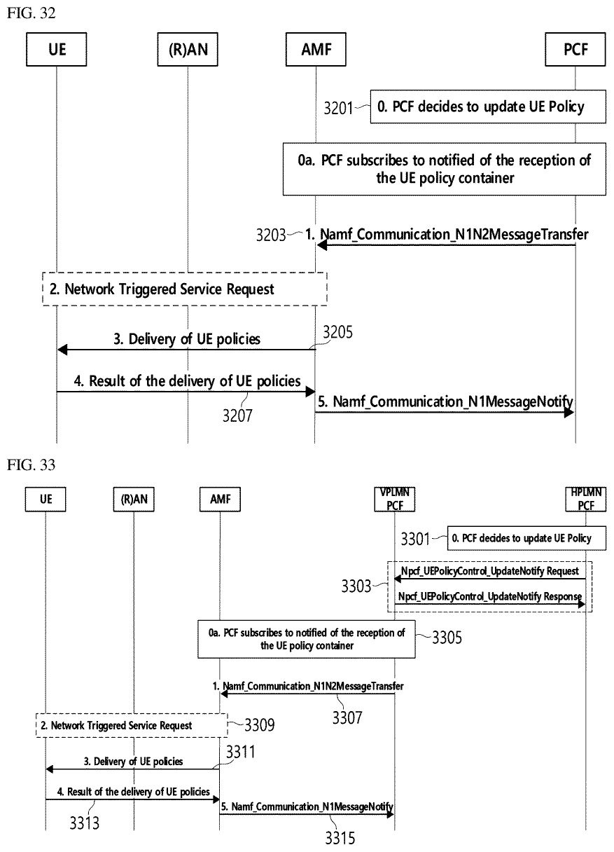

FIG. 32 illustrates the existing UE configuration update procedure, according to various embodiments of the present disclosure. FIG. 32 may show a UE configuration Update procedure of 4.2.4.3 of 3GPP TS 23.502. Specifically, FIG. 32 illustrates a procedure for providing DualSteer policy changed for a UE connected to an HPLMN.

Referring to FIG. 32, the DualSteer policy may be included in the UE route selection policy (URSP), or may be provided in the form of a separate rule other than the URSP. When the DualSteer policy is changed, the PCF that recognizes this may transmit the changed policy to the UE through the procedure of FIG. 32. This process may additionally perform a Network Triggered Service Request procedure depending on the status of the UE and the network.

First, the PCF may decide to provide a new DualSteer policy to the DualSteer device (3201). Herein, the DualSteer policy may be differentiated based on the DualSteer registration or DualSteer session status of the UE. For example, when only one of the SUPIs included in the DualSteer device is registered, all traffics are processed through the network to which the corresponding SUPI is connected. Meanwhile, when the second SUPI is registered, the policy may be changed so that certain traffic is processed through the network to which the second SUPI is connected.

The PCF transfers the DualSteer policy to the AMF, and this policy may be included in the PolicyAssociation (3201). The transferred DualSteer policy may be one of pieces of information described in Table 3, Table 4, or FIG. 18.

The AMF may receive policy information from the PCF (3203) and deliver it to the UE through NAS message (3205). The NAS message may be provided in the form of DL NAS Transport, UE Configuration Update Command, or Registration Accept message, and policy information may be included in the UE policy container, which may be included in payload container.

When the UE is connected through the VPLMN, the H-PCF may deliver the changed DualSteer policy to the V-PCF. Herein, Npcf_UEPolicyUpdateNotify Request message may be used to deliver policy to V-PCF. In addition, it may include accessible network information related to the second SUPI, prohibited RAN and PLMN information, available RAN and PLMN information, priority list, etc.

When the UE receives the changed policy, the UE may transmit the policy reception result to the network via UE Configuration Update Complete message (3207). As a result, the UE may optimize and utilize network resources according to the latest DualSteer policy.

FIG. 33 illustrates the existing UE configuration update procedure. according to an embodiment of the present disclosure. FIG. 33 illustrates a case of roaming in the embodiment of FIG. 32. Specifically, the UE configuration update procedure in a roaming situation illustrates a process of transferring DualSteer policy change items determined by the H-PCF of the HPLMN to the V-PCF of the VPLMN and the UE. The procedure of FIG. 32 may include operations in which the H-PCF transmits the DualSteer policy to the V-PCF, and the V-PCF transmits it to the UE via the AMF.

Referring to FIG. 33, the H-PCF may determine the necessity of changing the DualSteer policy, and decide to transfer it to the V-PCF and the UE (3301). The DualSteer policy changed in operation 3301 may be included in the form of URSP or a separate Rule.

The H-PCF may transfer the changed DualSteer policy to the V-PCF via the Npcf_UEPolicyControl_UpdateNotify Request message (3303). The message transferred in operation 3303 may include a UE policy container containing the DualSteer policy. The V-PCF may receive this and respond with an Npcf_UEPolicyControl_UpdateNotify Response message.

The V-PCF may subscribe to notifications regarding the reception of the UE policy container, which results in confirming whether the policy is successfully transferred to the UE (3305).

The V-PCF may transfer the changed DualSteer policy to the AMF via Namf_Communication_N1N2MessageTransfer message (3307). The AMF may receive it and prepare to transfer it to the UE.

If necessary, the AMF may perform a Network Triggered Service Request procedure (3309). This may be used for state synchronization between UE and network.

The AMF may transfer the changed DualSteer policy to the UE via NAS message (DL NAS Transport or UE Configuration Update Command, etc.) (3311). The DualSteer policy may be included in a structure of UE policy container and payload container to be transferred.

After receiving the policy, the UE may respond with the policy reception result to the AMF (3313). This may be done with the UE Configuration Update Complete message.

The AMF may notify the V-PCF of policy delivery result (3315). This may be done through the Namf_Communication_N1MessageNotify message.

According to an embodiment, the H-PCF may deliver the changed policy to the V-PCF, and the V-PCF may relay it to the UE. In addition, the DualSteer policy may maintain a hierarchical structure that transfers the policy of the HPLMN to the VPLMN and thus to the UE. In addition, it may support to efficiently apply the policy of the HPLMN even when the UE is connected to the VPLMN.

Therefore, the present disclosure may ensure that the changed policy of the HPLMN is accurately transmitted to the UE through the VPLMN, and the DualSteer function operates smoothly even while roaming.

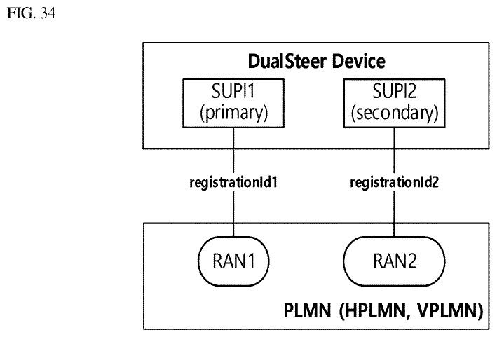

FIG. 34 illustrates an example of registering two SUPIs of a DualSteer device to different RANs, according to an embodiment of the present disclosure.

Referring to FIG. 34, RAN1 and RAN2 may belong to the same PLMN or may belong to different PLMNs. For example, the SUPI1 may be registered to the RAN1, and SUPI2 may be registered to the RAN2. In this situation, when the RAN1 and RAN2 are under the same access and mobility management function (AMF), there is no problem in distinguishing two registrations. However, when the RAN1 and RAN2 belong to different PLMNs or are under the different AMFs within the same PLMN, the SUPIs must be referenced to distinguish the two registrations. However, when utilizing the SUPI, there are disadvantages that its data size is large and it must be converted to a SUPI concealed identifier (SUCI) or a globally unique temporary identifier (GUTI) to be encrypted.

To solve this, registration ID (DSregId) may be introduced. The DSregId is a name used for convenience of explanation to indicate an identifier for identifying each connection of the DualSteer device, and is not limited to that name. The DSregId is a simple identifier assigned at the time of registration to distinguish each connection of the DualSteer device. The DSregId identifier may be referenced as a control identifier in the steering, switching, and splitting operations of DualSteer. For example, a command may be exchanged between the DualSteer device and the 5G core network to steer or switch a specific session or data from the first DSregId to the second DSregId. In other words, a policy may be provided to the DualSteer device so that the 5G core network steers or switches a specific session or data to a certain SUPI.

The DSregId may be used only within a single DualSteer device, or may be extended to distinguish registrations across the entire HPLMN (Home PLMN). The DSregId may be allocated by the DualSteer device itself or by the unified data management (UDM). Within the DualSteer device, the decentralized control function (DCF) may manage the DSregId. The DSregId may not only serve as a simple identifier, but also include radio access technology type (RATtype) information. The DSregId may allow the allocated information to be released in a deregistration procedure, and the DSregId recorded in the UDM or UE may be deleted.

When the DSregId is used to identify individual registrations or access networks, correlation ID (DScorrel) may be utilized separately to indicate correlation information between two DualSteer connections. The DScorrel may be allocated in the core network or UDM and then provided to a user equipment (UE). The DScorrel is used to manage the correlation between DualSteer connections or DualSteer sessions and may be deleted when necessary.

The introduction of DSregId and DScorrel allows for efficient and flexible control between DualSteer device and 5G core network, and effectively manages the correlation between registration and access.

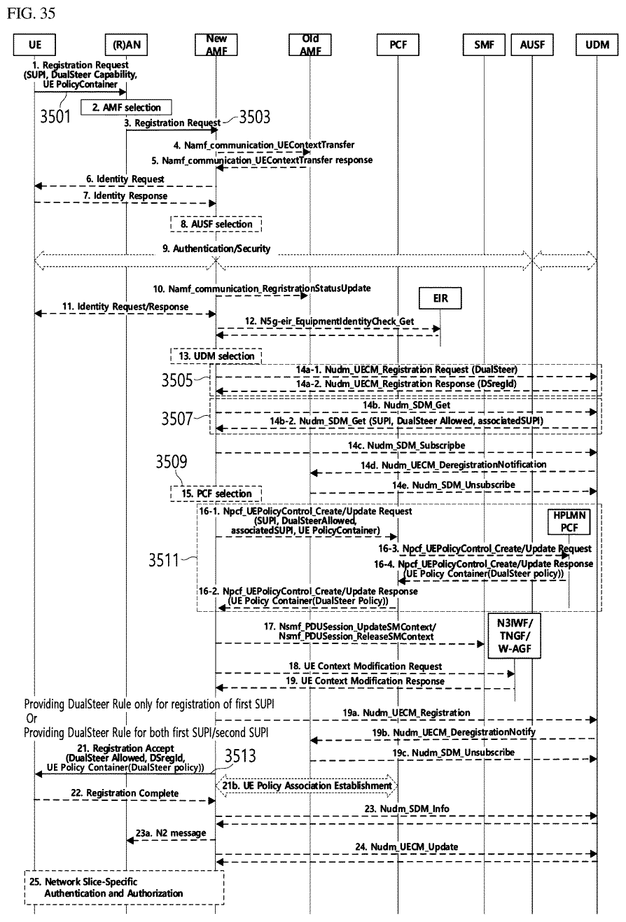

FIG. 35 illustrates an example of registration procedure and policy provision procedure of a UE, according to an embodiment of the present disclosure.

Referring to FIG. 35, registration may be performed for each of two SUPIs according to the DualSteer device registration procedure described above. The registration order may be preset as primary/secondary, or may be performed in any order, and may be adjusted according to a policy which is received by the DCF from the network or is preset. In addition, the access network of the first SUPI and the second SUPI must be different in at least one of PLMN, RAT, Cell, or FrequencyBand.

The detailed description of each main operation is as follows:

### [Registration Request 3501]

A DualSteer device may send a request to the network including the SUPI which is currently performing the registration procedure via the Registration Request message (3501). The message of the operation 3501 may include at least one of the following DualSteer related information:
(1) whether to support DualSteer (DualSteerCapable)
(2) UE policy container
(3) SUPI registration order (primary/secondary)
(4) whether to support simultaneous transmission
(5) DNN and S-NSSAI to which DualSteer is applied
(6) DSregId or DScorrel (optionally included)

According to an embodiment, whether to support DualSteer may be indicated by one bit of information element of 5G MM Capability, and the DualSteer related policy may be included in the UE policy container to be exchanged with the PCF. The UE policy container may include at least one of the following information:
(1) list of PSIs
(2) Indication of URSP Provisioning Support in EPS
(3) UE capability of reporting URSP rule enforcement to network
(4) UE capability of supporting VPLMN-specific URSP rules
(5) Whether to support DualSteer

### [AMF's VPLMN Processing (3503)]

When the currently connected PLMN is not the same as the HPLMN (VPLMN), the AMF may check whether the VPLMN may support DualSteer or has a DualSteer roaming agreement with the HPLMN. When DualSteer is not supported, it may switch to the normal registration procedure, or transmit a RegistrationReject message in operation 3503. In this situation, the DualSteer device may use the normal service by transmitting a new Registration Request excluding DualSteer Capability.

### [AMF UDM Registration 3505]

The AMF may currently register itself with UDM for mobility management of SUPI (3505). Herein, it may include at least one of pieces of information as following:
(1) whether to support DualSteer (DualSteerCapable)
(2) SUPI registration order
(3) whether to support simultaneous transmission
(4) DNN and S-NSSAI to which DualSteer is applied
(5) Registration identifier (DSregId) or DScorrel

The UDM may register DSregId with AMF ID and RATtype for SUPI. The response may include one or more additional information of DualSteer Allowed, linkedSUPI, DSregId, DScorrel, SUPI registration order, whether to apply simultaneous transmission, DNN to be used for DualSteer, and slice information to be used for DualSteer. DSregId may be generated by UDM.

### [Subscription Information Inquiry 3507]

The AMF may request SUPI subscription information from UDM, and thus receive at least one of DualSteer service allowance, linkedSUPI, DSregId, DScorrel, SUPI registration order, whether to apply simultaneous transmission, DNN to be used for DualSteer, or slice information to be used for DualSteer (3507). In addition, the AMF may verify the DualSteer policy and service availability based on the information received from UDM. When the DualSteer service is not allowed, registration may be processed as a normal registration or rejected.

### [PCF Selection 3509]

The AMF may select an appropriate PCF considering whether UE is roaming (3509). A roaming situation allows the V-PCF to be selected, and the V-PCF may additionally select the H-PCF. In the PCF selection process, considering whether SUPI, S-NSSAI, and DualSteer are supported, search may be performed via NRF. For the second SUPI, the same PCF as the first SUPI may be selected.

### [Policy Request for PCF (3511)]

The AMF may request UE Policy for the PCF (3511). The request of operation 3511 may further include at least one of DualSteer Capable, DualSteer allowed, linkedSUPI, DSregId, DScorrel, registration order of SUPI, whether to apply simultaneous transmission, DNN to be used for DualSteer, slice information to be used for DualSteer, or UE policy container. The V-PCF forwards the policy request to H-PCF and may refer to the subscription information of SUPI1 searched in UDR when creating DualSteer policy. The created DualSteer policy may be included in the UE policy container and forwarded to AMF. In a roaming situation, the policy may be forwarded from H-PCF to V-PCF.

### [Registration Accept (3513)]

The AMF may accept or reject registration through Registration Accept message (3513). The Registration Accept message may be transmitted as NAS message including at least one of DualSteer Allowed, linkedSUPI, DSregId, DScorrel, SUPI registration order, whether to apply simultaneous transmission, DNN to be used for DualSteer, slice information to be used for DualSteer, or DualSteer policy. The DualSteer policy is included in UE policy container, and DualSteer device may determine operation based on it.

According to an embodiment, when the first SUPI is successfully registered, the DualSteer device may perform registration of second SUPI according to the DualSteer policy. The access network selection of the second SUPI must be different from the network registered by the first SUPI in at least one of PLMN, RAT, and Cell, and may refer to the priority in DualSteer policy. The DualSteer device may determine traffic steering and switching according to registered SUPI.

According to an embodiment, when the DualSteer policy to be provided to the second SUPI is the same as the DualSteer policy provided to the first SUPI of the DualSteer device, provision of DualSteer policy may be omitted. According to an embodiment, the DualSteer device always registers the first SUPI, and when the first SUPI fails to register, it may not register the second SUPI. This registration information may be managed in software of DualSteer device and UDM/UDR of network.

Such procedures may allow for efficient network registration and policy management of the DualSteer devices, and may provide optimized services in various network environments.

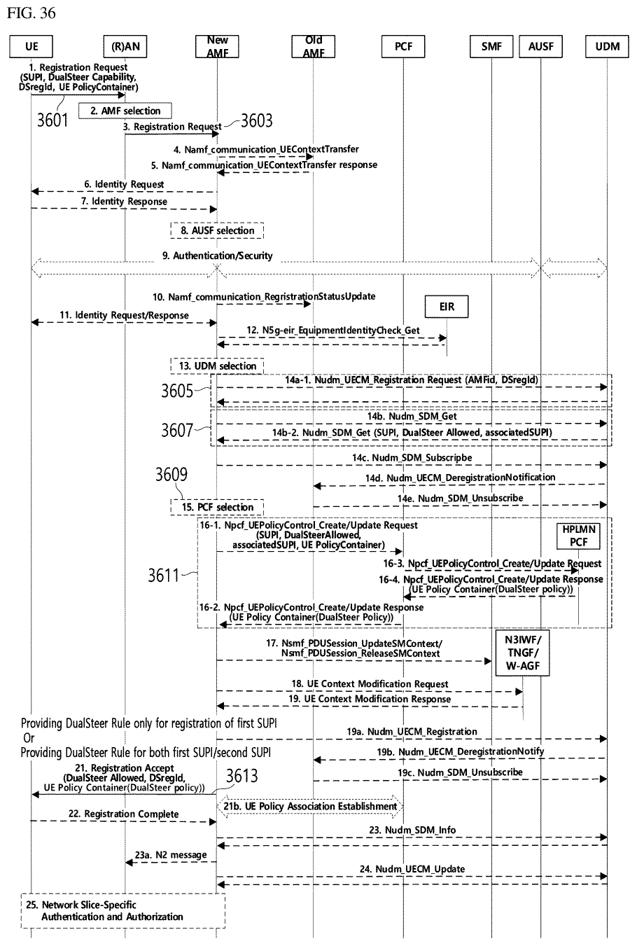

FIG. 36 illustrates another example of a registration and policy provision procedure of a UE, according to an embodiment of the present disclosure.

Referring to FIG. 36, when comparing FIG. 36 with FIG. 35, a 5G network generates and manages DSregId in FIG. 35, whereas the DualSteer device may directly generate and manage DSregID in FIG. 36. The specific operations are as follows.

### [Registration Request (3601)]

A DualSteer device may generate DSregId and transmit a Registration Request message including the generated DSregId to AMF (3601). The Registration Request message may include at least one of DualSteer Capability, UE policy container, registration order of SUPI (primary/secondary), simultaneous transmission, DNN, or S-NSSAI information. The DSregId may be an identifier generated by the DualSteer device, which may be subsequently used in steering, switching, and splitting procedures.

### [AMF's VPLMN Verification and Processing (3603)]

The operation 3603 is the same as the operation 3503.

### [AMF UDM Registration (3605)]

The operation 3605 is the same as the operation 3505.

### [Request Subscription Inquiry (3607)]

The operation 3607 is the same as the operation 3507.

### [Select PCF (3609)]

The operation 3609 is the same as the operation 3509.

[Request Policy with PCF (3611)]

The operation 3611 is the same as the operation 3511.

### [Registration Accept (3613)]

The operation 3613 is the same as the operation 3513.

The DSregId utilization method may be divided into Steering/Switching/Splitting control, access network identification, and policy application. In Steering/Switching/Splitting control, the DSregId identifies the access network of each SUPI and may be used to identify access network for specific traffic. In access network identification, the DualSteer device may distinguish the PLMN, RAT, and Cell connected to each SUPI through the DSregId. In policy application, it may be used as an identifier for traffic routing in the DualSteer policy.

According to an embodiment, since the DualSteer device directly generates and manages the DSregID, device-centered identifier management, network load reduction, and terminal autonomy may be increased. In the case of device-centered identifier management, since the DualSteer device generates DSregId, network load may be reduced and management efficiency may be increased. In the case of network load reduction, DSregId generation and management are performed at the terminal, so network resource usage may be optimized. When terminal autonomy is increased, the DualSteer device may manage network connections more flexibly by utilizing self-generated DSregId.

Through this procedure, collaboration between the DualSteer device and the network may be strengthened, and flexibility and efficiency of DualSteer policy application may be improved.

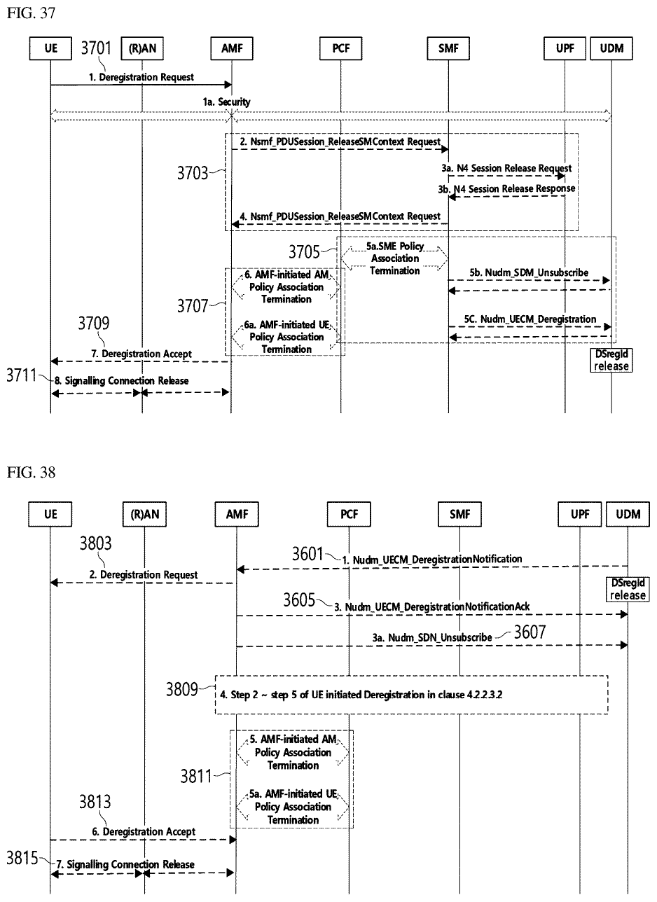

FIG. 37 illustrates a deregistration procedure of a UE, according to an embodiment of the present disclosure. Specifically, FIG. 37 specifically illustrates a deregistration procedure of a UE for SUPI deregistration of the DualSteer device. In particular, FIG. 37 describes a deregistration order between the first SUPI and the second SUPI belonging to the DualSteer device, and management of the DSregID and the DScorrel.

Referring to FIG. 37, the deregistration order is determined according to the policy of the DualSteer device, and according to an embodiment, the second SUPI may be deregistered first and then the first SUPI may be deregistered. A deregistration request message, Deregistration Request may include the DSregId together with the SUPI. The DSregId is an identifier generated within the DualSteer device or assigned by the network, and may be used to manage registration status and connection information.

The deregistration request may be initiated with a Deregistration Request message (3601). The DualSteer device includes SUPI information that is subject to register in the deregistration request message, and when both the first SUPI and the second SUPI are registered, the second SUPI may be deregistered first. Herein, the Deregistration Request message may include DSregId.

The DSregId is a registration identifier associated with the SUPI, which may facilitate identification and control between the DualSteer device and the network.

When the deregistration request is received, the AMF processes it and may proceed with deregistration in cooperation with other components of the network (3703).

The UDM may deregister the registration status of the SUPI based on the registered information, and treat the DSregId and DScorrel information if necessary (3705). The DScorrel is an identifier that indicates the relationship between the first SUPI and the second SUPI of the DualSteer device, and may delete the corresponding information along with Deregistration to allow it to be no longer referenced. This process may be important for maintaining the consistency of the registration status of the DualSteer device and network resources.

During the deregistration procedure, the AMF manages the policy association, and may transmit a message to terminate the policy association or update the registration information based on data of the UDM (3707). Such procedure includes the AMF-initiated Policy Association Termination step, which may release the network resources related to the policy information.

Once the deregistration procedure is completed, the AMF may transmit a deregistration accept message to the DualSteer device (3709). This message conveys the result of approval for the Deregistration Request, so that the connection with the network may be released.

Finally, the signaling connection is terminated through the signaling connection release step, so that the deregistration procedure may be terminated (3711).

FIG. 37 shows deregistration of the DualSteer device by simplifying such procedure, especially with respect to the management and deregistration of identifier information such as DSregId. The deregistration is performed sequentially considering the priorities of the first SUPI and the second SUPI, and stability may be guaranteed by treating network resources and policy information.

FIG. 38 illustrates a deregistration procedure initiated in a network, according to an embodiment of the present disclosure. Specifically, FIG. 38 illustrates a deregistration procedure initiated in a network as defined in 4.2.2.3.3 of 3GPP TS 23.502. This may be a procedure for handling a special situation that may occur in the operation (operation 5c of 3705) of FIG. 37, i.e., a case where deregistration of the first SUPI is requested while the second SUPI is not deregistered.

The procedure of FIG. 38 may be started when the UDM sends Nudm_UECM_DeregistrationNotification to AMF (3801). Thereafter, the AMF may send the Deregistration Request the UE to (3803), and respond with Nudm_UECM_DeregistrationNotificationAck to the UDM (3805). Subsequently, the subscription information may be released through Nudm_SDN_Unsubscribe (3707).

In the operation 3809, UE-initiated deregistration procedure (step 2-5 of clause 4.2.2.3.2) may be performed. Afterwards, the AMF may terminate AM policy association and UE policy association (3811), and send Deregistration Accept to the UE (3813).

Finally, connection may be terminated through signaling connection release (3815).

According to an embodiment, considering the special nature of the DualSteer device, when a request for deregistration is received for the first SUPI in a situation where the first SUPI and the second SUPI are registered together, the network may automatically perform deregistration of the second SUPI as well. This is for consistent state management of the DualSteer device, and when deregistration of the SUPI designated as the first SUPI is requested, the associated second SUPI is also deregistered, thereby maintaining the consistency of the system.

Through this procedure, systematic deregistration is enabled considering the dependency between two SUPIs of the DualSteer device, and efficient management of network resources is enabled.

### [NRF Registration and Search]

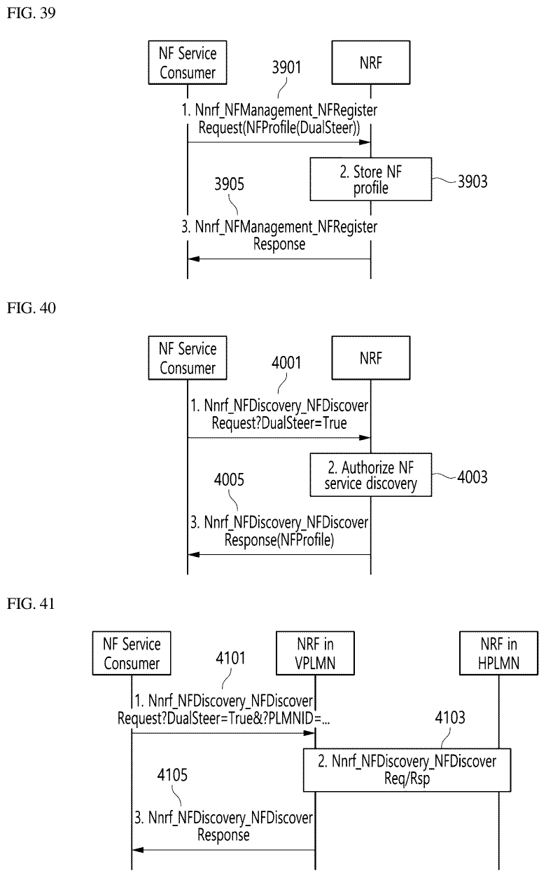

FIG. 39 illustrates an example of registering a functional element within a network, according to an embodiment of the present disclosure. Specifically, FIG. 39 illustrates a procedure in which functional elements of a 5G core network (5GC) register themselves with a network function repository function (NRF).

Referring to FIG. 39, the NRF manages the registration of each functional element within the 5GC, and in particular, may manage registration information of functional elements such as SMF, UPF, and PCF related to DualSteer service.

The specific registration procedure is as follows.

In the operation 3901, the NF service consumer may send Nnrf_NFManagement_NFRegister Request to the NRF. Nnrf_NFManagement_NFRegister Request may include DualSteer related information in NFProfile.

In the operation 3903, the NRF may store the received NF profile.

In the operation 3905, the NRF may respond registration completion with Nnrf_NFManagement_NFRegister Response.

Since only some of the functional elements such as SMF, UPF, and PCF may support the DualSteer service, other functional elements using them must be able to know whether to support DualSteer service. To this end, each functional element includes its DualSteer service support in NFProfile when registering with NRF. NFProfile more specifically includes the corresponding profiles of AMFProfile, SMFprofile, UPFprofile, or PCFprofile, and each profile specifies whether to support DualSteer based on the DualSteer delay. That is, at least one of NFProfile, AMFProfile, SMFprofile, UPFprofile, or PCFprofile may specify whether to support DualSteer.

In particular, the above-described profile may include whether to support DualSteer along with information such as the existing SUPIrange, DNN, S-NSSAI, etc., and these pieces of information may be combined and used, thereby finding an appropriate service provider when other functional elements within the network requires the DualSteer service.

FIG. 40 illustrates an example for searching a functional element within the network, according to an embodiment of the present disclosure. Specifically, FIG. 40 shows a procedure for searching functional elements supporting DualSteer service in a 5G network.

The search procedure may operate as follows.

In the operation 4001, the NF service consumer may transmit an Nnrf_NFDiscovery_NFDiscover Request to the NRF. Herein, whether to support the DualSteer service, such as DualSteer-True may be additionally included in the query parameter.

In the operation 4003, the NRF may authorize and process the requested service discovery.

In the operation 4005, the NRF may return NFProfile information of the searched functional elements through Nnrf_NFDiscovery_NFDiscover Response.

In order to provide the DualSteer service, cooperation between multiple functional elements may be required. The AMF searches for SMF, the SMF searches for other SMFs or UPFs, and the AMF and SMF search for PCFs. Herein, each functional element supporting the DualSteer service must be found. To this end, whether to support the DualSteer service may be additionally included in the query parameter, along with NFType, when requesting the search. In addition, it may be used in combination with search conditions such as DNN and S-NSSAI that were previously used.

The NRF provides a response including NFProfile for such search request, in which the NFProfile may include the corresponding profile of AMFProfile, SMFprofile, UPFprofile, or PCFprofile, along with whether to support DualSteer service, thereby allowing network function elements to find appropriate partners necessary for providing the DualSteer service.

FIG. 41 illustrates a search for a PLMN-to-PLMN functional element, according to an embodiment of the present disclosure. Specifically, FIG. 41 illustrates a procedure for searching for function elements supporting the DualSteer service between different PLMNs.

The search procedure may be configured as follows.

In the operation 4101, the NF service consumer may transmit an Nnrf_NFDiscovery_NFDiscover Request to the NRF of the VPLMN. The Nnrf_NFDiscovery_NFDiscover Request further includes a PLMNID along with DualSteer=True as query parameters, and the PLMNID may include a Mobile Country Code (MCC) of 3 digits and a Mobile Network Code (MNC) of 2˜3 digits included in the SUPI that requests the DualSteer service.

In the operation 4103, the NRF of the VPLMN may transceive an Nnrf_NFDiscovery_NFDiscover Request/Response to the NRF of the HPLMN.

In the operation 4105, the NRF of the VPLMN may finally return the search result as an Nnrf_NFDiscovery_NFDiscover Response.

Such search procedure occurs mainly in roaming situations, and may be necessary when a DualSteer service user roams to a PLMN (VPLMN or SPLMN) other than the HPLMN. In particular, when the SMF of the VPLMN (VSMF) needs to request session control for the DualSteer service to the SMF of the HPLMN (HSMF), it is necessary to search for the HSMF first.

When the NRF of the VPLMN transfers the search request to the NRF of the HPLMN, the consistent DualSteer service may be allowed between PLMNs by transferring the NFtype and whether to support the DualSteer service.

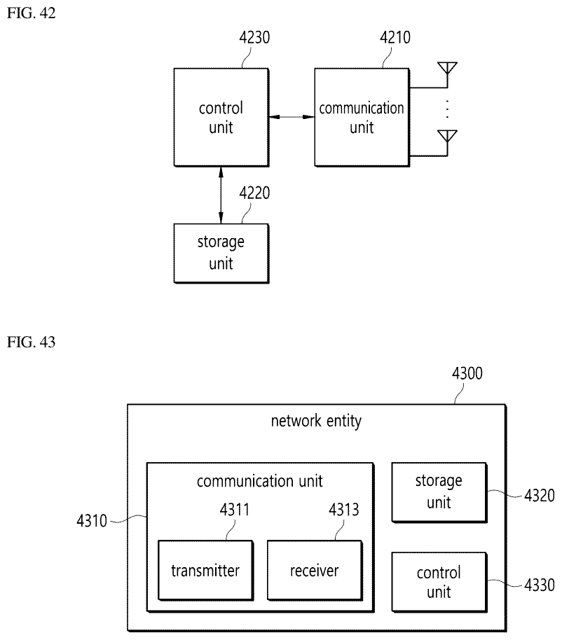

FIG. 42 illustrates a configuration diagram of a terminal in a wireless communication system, according to various embodiments of the present disclosure. The configuration illustrated in FIG. 42 may be understood as a configuration of a terminal. The terms “unit”, “part”, etc. used below mean a unit for processing at least one function or operation, which may be implemented by hardware or software, or a combination of hardware and software.

Referring to FIG. 42, the terminal may include a communication unit 4210, a storage unit 4220, and a control unit 4230.

The communication unit 4210 may perform functions for transmitting and receiving signals through a wireless channel. For example, the communication unit 4210 may perform a conversion function between a baseband signal and a bit stream according to physical layer specifications of the system. For example, when transmitting data, the communication unit 4210 may generate complex symbols by encoding and modulating a transmission bit stream. When receiving data, the communication unit 4210 may restore a reception bit stream by demodulating and decoding a baseband signal. In addition, the communication unit 4210 may up-convert a baseband signal into an RF band signal and then transmit it through an antenna, and down-convert an RF band signal received through the antenna into a baseband signal. For example, the communication unit 4210 may include a transmission filter, a reception filter, an amplifier, a mixer, an oscillator, a DAC, an ADC, etc.

In addition, the communication unit 4210 may include a plurality of transmit/receive paths. In addition, the communication unit 4210 may include at least one antenna array composed of a plurality of antenna elements. In terms of hardware, the communication unit 4210 may include digital circuits and analog circuits (e.g., radio frequency integrated circuit (RFIC)). Here, the digital circuits and analog circuits may be implemented in one package. In addition, the communication unit 4210 may include a plurality of RF chains. In addition, the communication unit 4210 may perform beamforming.

The communication unit 4210 transmits and receives signals as described above. Accordingly, all or part of the communication unit 4210 may be referred to as a “transmitter”, a “receiver”, or a “transceiver”. Additionally, transmission and reception performed through a wireless channel in the following description may imply that above-described processing is performed by the communication unit 4210.

The storage unit 4220 may store data such as basic programs, application programs, and setting information for the operation of the terminal. The storage unit 4220 may be composed of volatile memory, nonvolatile memory, or a combination of volatile memory and nonvolatile memory. In addition, the storage unit 4220 may provide stored data according to a request from the control unit 4230.

The control unit 4230 may control overall operations of the terminal. For example, the control unit 4230 may transmit and receive signals through the communication unit 4210. In addition, the control unit 4230 may record and read data in the storage unit 4220. The control unit 4230 may perform functions of the protocol stack required by the communication standard. To this end, the control unit 4230 may include at least one processor or microprocessor, or may be a part of a processor. In addition, a part of the communication unit 4210 and the control unit 4230 may be referred to as a communication processor (CP).

According to various embodiments, the control unit 4230 may control the terminal to perform operations according to various embodiments performed by the above-described terminal.

FIG. 43 illustrates the configuration of a network entity in a wireless communication system according to various embodiments of the present disclosure. The network entity of the present disclosure is a concept that includes a network function according to the system implementation. The terms “unit”, “part”, etc. used below mean a unit that processes at least one function or operation, which may be implemented by hardware or software, or a combination of hardware and software.

A network entity 4300 according to various embodiments of the present disclosure may include a communication unit 4310, a storage unit 4320, and a control unit 4330 that controls overall operation of the network entity 4300. The communication unit 4310 transmits and receives signals with other network entities. Accordingly, all or part of the communication unit 4310 may be referred to as a “transmitter” 4311, a “receiver” 4313, or a “transceiver” 4310. The storage unit 4320 stores data such as a basic program, an application program, and setting information for the operation of the network entity 4300. The storage unit 4320 may be composed of volatile memory, nonvolatile memory, or a combination of volatile memory and nonvolatile memory. In addition, the storage unit 4320 provides stored data according to a request of the control unit 4330. The control unit 4330 controls overall operations of the network entity 4300. For example, the control unit 4330 transmits and receives signals through the communication unit 4310. In addition, the control unit 4330 records and reads data in the storage unit 4320. In addition, the control unit 4330 may perform functions of a protocol stack required by a communication standard. For this purpose, the control unit 4330 may include a circuit, an application-specific circuit, at least one processor or microprocessor, or may be a part of a processor. In addition, a part of the communication unit 4310 and the control unit 4330 may be referred to as a communication processor (CP). The control unit 4330 may control the network entity 4300 to perform any one of the various embodiments of the present disclosure. The communication unit 4310 and the control unit 4330 do not necessarily have to be implemented as separate modules, and may of course be implemented as a single component in the form of a single chip or software block. The communication unit 4310, the storage unit 4320, and the control unit 4330 may be electrically connected. In addition, the operations of the network entity 4300 may be realized by providing a storage unit 4320 storing the corresponding program code within the network entity 4300. A network entity 4300 includes a network node, and may be any one of a base station, RAN, AMF, NSSF, UDR, SMF, UPF, NF, NEF, NRF, CF, NSSF, UDM, AF, AUSF, SCP, UDSF, NEF, DN, context storage, OAM, EMS, configuration server, and ID management server.

The methods according to the embodiments described in the claims or specification of the present disclosure may be implemented in the form of hardware, software, or a combination of hardware and software.

In the case of software implementation, a computer-readable storage medium storing one or more programs (software modules) may be provided. The one or more programs stored in the computer-readable storage medium are configured for execution by one or more processors in an electronic device. The one or more programs include instructions that cause the electronic device to execute the methods according to the embodiments described in the claims or specification of the present disclosure.

These programs (software modules, software) may be stored in random access memory, non-volatile memory including flash memory, read only memory (ROM), electrically erasable programmable read only memory (EEPROM), magnetic disc storage devices, compact disc-ROM (CD-ROM), digital versatile discs (DVDs) or other forms of optical storage devices, magnetic cassettes. Alternatively, they may be stored in a memory composed of a combination of some or all of them. In addition, multiple configuration memories may exist.

In addition, the program may be stored on an attachable storage device that is accessible via a communications network, such as the Internet, an intranet, a local area network (LAN), a wide area network (WAN), or a storage area network (SAN), or a combination thereof. The storage device may be connected to a device performing an embodiment of the present disclosure via an external port. In addition, a separate storage device on the communications network may be connected to a device performing an embodiment of the present disclosure.

In the specific embodiments of the present disclosure described above, the components included in the disclosure are expressed in a singular or plural form depending on the specific embodiment presented. However, the singular or plural expressions are selected appropriately for the presented situation for the convenience of explanation. It should be appreciated that the present disclosure is not limited to singular or plural components, but even if a component is expressed in the plural form, it may be composed of the singular form, or even if a component is expressed in the singular form, it may be composed of the plural form.

Meanwhile, although the detailed description of the present disclosure has described specific embodiments, it is obvious that various modifications are possible within the scope of the present disclosure. Therefore, the scope of the present disclosure should not be limited to the described embodiments, but should be determined by the scope of the claims described below as well as the equivalents of the claims.

What is claimed is:

1. A method for operating a registration for a network function repository function (NRF) by a network function element supporting multi-access of a wireless communication system, the method comprising:
requesting, by the network function element, the registration with the NRF,
wherein the requesting of the registration includes whether to support multi-access, and whether to support multi-access is included in at least one of NFProfile, AMFProfile, SMFProfile, UPFProfile or PCFProfile.

2. A method for searching a network function element in a wireless communication system, the method comprising:
specifying an NFType of the network function element to be searched;
including whether to support DualSteer service as a search condition; and
requesting a search for an NRF using query parameters including the NFType and whether to support the DualSteer service.

3. The method of claim 2, wherein the query parameters further comprise a public land mobile network ID (PLMN ID).

4. The method of claim 1, wherein whether to support the multi-access includes whether to support the DualSteer.

5. A method for providing DualSteer policy in a wireless communication system, the method comprising:
identifying traffic characteristics of an individual subscription permanent identifier (SUPI);
determining radio access technology (RAT) selection information based on the identified traffic characteristics; and
generating the DualSteer policy including the RAT selection information.

6. The method of claim 5, further comprising:
including the generated DualSteer policy in a UE policy container to transfer the same to a terminal.

7. The method of claim 5, wherein the radio access technology (RAT) selection information further comprises public land mobile network (PLMN) information.

8. The method of claim 5, wherein the radio access technology (RAT) selection information is expressed in a priority order.

9. The method of claim 5, wherein the DualSteer policy is provided as part of a UE route selection policy (URSP) or a steering of roaming (SoR).

10. The method of claim 5, wherein a reference for the individual SUPI is referenced as an identifier for each connection of the corresponding SUPI of the DualSteer device to an access network.

11. The method of claim 5, wherein the traffic characteristics are indicated by at least one of an application ID, a data network name (DNN), a single network slice selection assistance information (S-NSSAI), a transmitting or receiving IPv4 address, an IPv6 prefix, a transmitting or receiving port number, a protocol identifier, an IPv4 service type, an IPv6 traffic class and flow label, a security parameter index, a packet filter direction, a transmitting MAC address, a receiving MAC address, an EtherType, a VLAN identifier (VID) of a customer VLAN TAG (C-TAG) or a service VLAN TAG (S-TAG), and a priority code point (PCP)/drop eligible indicator (DEI) of the C-TAG or the S-TAG.

12. The method of claim 5, wherein when the DualSteer policy is the same as a policy already provided to the DualSteer device, the DualSteer policy is not provided to other SUPIs of the DualSteer device.

13. An apparatus for providing DualSteer policy in a wireless communication system, the apparatus comprising:
a transceiver; and
a control unit operably connected to the transceiver,
wherein the control unit,
identifies traffic characteristics of an individual subscription permanent identifier (SUPI),
determines radio access technology (RAT) selection information based on the identified traffic characteristics, and
generates the DualSteer policy including the RAT selection information.

14. The apparatus of claim 13, wherein the radio access technology (RAT) selection information further comprises public land mobile network (PLMN) information.

15. The apparatus of claim 13, wherein the radio access technology (RAT) selection information is expressed in a priority order.

16. The apparatus of claim 13, wherein the DualSteer policy is provided as a part of a UE route selection policy (URSP) or a steering of roaming (SoR).

17. The apparatus of claim 13, wherein a reference for the individual SUPI is referenced as an identifier for each connection of the corresponding SUPI of the DualSteer device to an access network.

18. The apparatus of claim 13, wherein the traffic characteristics are indicated by at least one of an application ID, a data network name (DNN), a single network slice selection assistance information (S-NSSAI), a transmitting or receiving IPv4 address, an IPv6 prefix, a transmitting or receiving port number, a protocol identifier, an IPv4 service type, an IPv6 traffic class and flow label, a security parameter index, a packet filter direction, a transmitting MAC address, a receiving MAC address, an EtherType, a VLAN identifier (VID) of a customer VLAN TAG (C-TAG) or a service VLAN TAG (S-TAG), and a priority code point (PCP)/drop eligible indicator (DEI) of the C-TAG or the S-TAG.

19. The apparatus of claim 13, wherein when the DualSteer policy is the same as a policy already provided to the DualSteer device, the DualSteer policy is not provided to other SUPIs of the same DualSteer device.

20. The apparatus of claim 13, wherein the control unit includes the generated DualSteer policy in a UE policy container to transfer the same to a terminal.
